(19) United States
(12) Patent Application Publication
(10) Pub. No.: US 2014/0302314 A1
(43) Pub. Date: Oct. 9, 2014

(54) PRESSURE-SENSITIVE ADHESIVE COMPOSITION, AND PRESSURE-SENSITIVE ADHESIVE SHEET

(71) Applicant: NITTO DENKO CORPORATION, OSAKA (JP)

(72) Inventors: Kyoko Takashima, OSAKA (JP); Yu Morimoto, OSAKA (JP); Kazuma Mitsui, OSAKA (JP); Kousuke Yonezaki, OSAKA (JP); Tsunaki Kitahara, OSAKA (JP)

(21) Appl. No.: 14/247,704

(22) Filed: Apr. 8, 2014

(30) Foreign Application Priority Data
Apr. 9, 2013 (JP) 2013-081392

(51) Int. Cl. C09J 133/08; C09J 7/02

(52) U.S. Cl. CPC C09J 133/08; C09J 7/0217; C09J 2433/00
USPC 428/355 AC; 524/106

(57) ABSTRACT

Provided is a water-dispersible acrylic pressure-sensitive adhesive composition which can form a pressure-sensitive adhesive layer excellent in antistatic property, repeeling property (light peeling property), and appearance property. The repeelable water-dispersible acrylic pressure-sensitive adhesive composition of the present invention contains an acrylic emulsion-based polymer composed of 70 to 99.5% by weight of a (meth)acrylic acid alkyl ester and 0.5 to 10% by weight of a carboxyl group-containing unsaturated monomer as monomer components, a crosslinking agent, an ionic compound, and a nonionic surfactant with an HLB value of 6 or more.

### BACKGROUND OF THE INVENTION

1. Field of the Invention

The present invention relates to a water-dispersible acrylic pressure-sensitive adhesive composition which can form a repeelable pressure-sensitive adhesive layer. More particularly, the present invention relates to a water-dispersible acrylic pressure-sensitive adhesive composition which can forma pressure-sensitive adhesive layer excellent in antistatic property, repeeling property (light peeling property), and appearance property. The present invention also relates to a pressure-sensitive adhesive sheet having a pressure-sensitive adhesive layer composed of the pressure-sensitive adhesive composition.

2. Description of the Related Art

In the production and processing step of an optical member (optical material) including an optical film to be used for a polarizing plate, a retardation plate, an anti-reflection plate, etc., for the purpose of preventing scratching and staining on the surface, improving the cutting processability, suppressing cracks, and the like, a surface protective film is used while being bonded to the surface of an optical member (reference to Patent Documents 1 and 2). As the surface protective film, a repeelable pressure-sensitive adhesive sheet obtained by forming a repeelable pressure-sensitive adhesive layer on the surface of a plastic film substrate has been usually used.

Conventionally, solvent type acrylic pressure-sensitive adhesives have been used as a pressure-sensitive adhesive for surface protective films (reference to Patent Documents 1 and 2); however, since these solvent type acrylic pressure-sensitive adhesives contain an organic solvent, it has been tried to replace these solvent type acrylic pressure-sensitive adhesives with water-dispersible acrylic pressure-sensitive adhesives from the viewpoint of working environments at the time of application (reference to Patent Documents 3 to 5).

These surface protective films are required to exhibit sufficient tackiness during the time when the surface protective films are bonded to optical members. These surface protective films are also required to have excellent peeling property (repeeling property) since the surface protective films are peeled after being used in, for example, the production step for optical members. Additionally, in order to have excellent repeeling property, the surface protective films are needed to have low peeling strength (light peeling property).

In general, since a surface protective film and an optical member are made of a plastic material, they have a high electrical insulating property and generate static electricity at the time of friction or peeling off. Accordingly, when a surface protective film is peeled off from an optical member such as a polarizing plate, static electricity is generated, and if voltage is applied to a liquid crystal in the state where the static electricity generated at that time remains, it leads to the problems that the orientation of liquid crystal molecules is lost and a panel is defective.

Further, the existence of static electricity may possibly cause other problems such as attraction of dust and waste or deterioration of workability. Accordingly, in order to solve the above-mentioned problems, a surface protective film is subjected to various kinds of antistatic treatments.

Disclosed as a trial for suppressing electrification of static electricity is a method for antistatic treatment by adding a surfactant with a low molecular weight to a pressure-sensitive adhesive and transferring the surfactant to an object to be protected from the pressure-sensitive adhesive (e.g., reference to Patent Document 6). However, in such a method, the added surfactant with a low molecular weight is easy to bleed to the pressure-sensitive adhesive surface, and in the case where the method is employed for a surface protective film, there is concern of stains to an adherend (object to be protected).

Further, a pressure-sensitive adhesive composition containing an ionic liquid together with a polymer containing a reactive surfactant as a monomer component is also disclosed (reference to Patent Document 7). A pressure-sensitive adhesive layer obtained herein suppresses the bleeding out of the ionic liquid and realizes an antistatic property and a low staining property by coordinating the ether group or ester group contained in the reactive surfactant to the ionic liquid. However, the pressure-sensitive adhesive layer in this case may have an appearance problem due to production of dents, gel, etc. on the surface, and is thus inferior in workability in a step of appearance inspection of an optical member or the like. This causes a problem.

### PRIOR ART DOCUMENTS

### Patent Documents

Patent Document 1: JP-A-11-961

Patent Document 2: JP-A-2001-64607

Patent Document 3: JP-A-2001-131512

Patent Document 4: JP-A-2003-27026

Patent Document 5: Japanese Patent No. 3810490

Patent Document 6: JP-A 9-165460

Patent Document 7: JP-A-2007-217441

As described above, the foregoing problems have not been solved yet in good balance by any of the mentioned means, and in a technical field relevant to electronic appliances where electrification and stains become particularly serious problems, it is difficult to satisfy further improvements of a surface protective film having an antistatic property or the like, and presently, no water-dispersible acrylic pressure-sensitive adhesive excellent in antistatic property, repeeling property (light peeling property), and appearance property is made available.

### SUMMARY OF THE INVENTION

Accordingly, an object of the prevention invention is to provide a water-dispersible acrylic pressure-sensitive adhesive composition which can form a pressure-sensitive adhesive layer excellent in antistatic property, repeeling property (light peeling property), and appearance property and also to provide a pressure-sensitive adhesive sheet having a pressure-sensitive adhesive layer composed of the pressure-sensitive adhesive composition.

The inventors of the present invention have made various investigations to achieve the above object and found it possible to obtain a water-dispersible acrylic pressure-sensitive adhesive composition which contains a specified acrylic emulsion-based polymer produced from raw material monomers with specified composition, a crosslinking agent, an ionic compound, and a nonionic surfactant having a specified HLB value as constituent components and which can form a pressure-sensitive adhesive layer excellent in antistatic property, repeeling property (light peeling property), and appearance property. This finding has led to completion of the present invention.

That is, a repeelable water-dispersible acrylic pressure-sensitive adhesive composition according to the present invention (may be simply referred to as “pressure-sensitive adhesive composition”) is characterized by containing an acrylic emulsion-based polymer composed of 70 to 99.5% by weight of a (meth)acrylic acid alkyl ester and 0.5 to 10% by weight of a carboxyl group-containing unsaturated monomer as monomer components, a crosslinking agent, an ionic compound, and a nonionic surfactant with an HLB value of 6 or more.

In the pressure-sensitive adhesive composition of the present invention, preferably, the nonionic surfactant includes an acetylene structure.

In the pressure-sensitive adhesive composition of the present invention, preferably, the nonionic surfactant includes an acetylenediol structure.

In the pressure-sensitive adhesive composition of the present invention, preferably, the ionic compound contains a fluorine atom-containing anion.

In the pressure-sensitive adhesive composition of the present invention, preferably, the ionic compound contains a nitrogen atom-containing anion.

In the pressure-sensitive adhesive composition of the present invention, preferably, the ionic compound contains a sulfonyl group-containing anion.

In the pressure-sensitive adhesive composition of the present invention, preferably, the ionic compound is an ionic liquid and the ionic liquid contains at least one cation selected from the group consisting of cations represented by the following formulas (A) to (E):

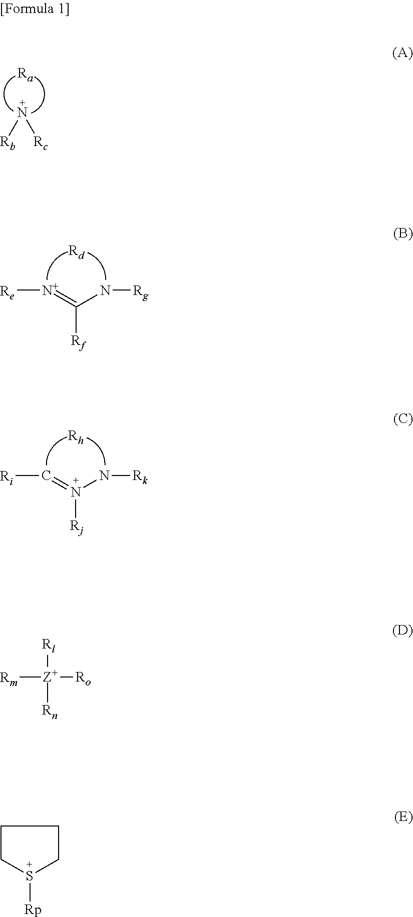

In formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent.

In formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group.

In formula (C), Rₕ represents a hydrocarbon group of 2 to 20 carbon atoms, part of the hydrocarbon group may be a heteroatom-substituted functional group, Rᵢ, Rⱼ, and Rₖare the same or different and each represent hydrogen or a hydrocarbon group of 1 to 16 carbon atoms, and part of the hydrocarbon group may be a heteroatom-substituted functional group.

In formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent.

In formula (E), Rₚ represents a hydrocarbon group of 1 to 18 carbon atoms, and part of the hydrocarbon group may be a heteroatom-substituted functional group.

In the pressure-sensitive adhesive composition of the present invention, preferably, the ionic liquid is of at least one selected from the group consisting of imidazolium-containing salt type, pyridinium-containing salt type, morpholinium-containing salt type, pyrrolidinium-containing salt type, piperidinium-containing salt type, ammonium-containing salt type, phosphonium-containing salt type, and sulfonium-containing salt type.

In the pressure-sensitive adhesive composition of the present invention, preferably, the ionic liquid contains at least one cation selected from the group consisting of cations represented by the following formulas (a) to (d):

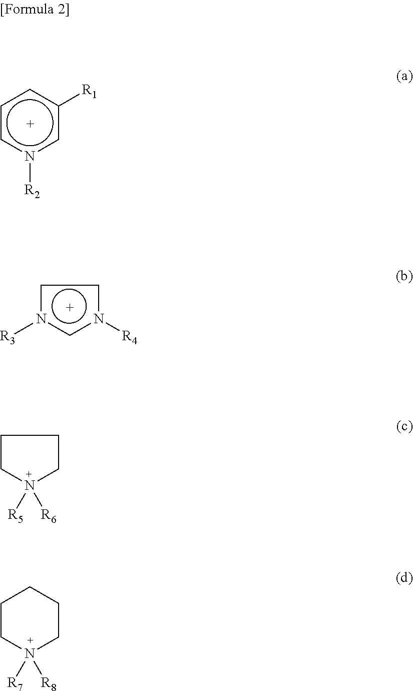

In formula (a), R₁ represents hydrogen or a hydrocarbon group of 1 to 3 carbon atoms, and R₂ represents hydrogen or a hydrocarbon group of 1 to 5 carbon atoms.

In formula (b), R₃ represents hydrogen or a hydrocarbon group of 1 to 3 carbon atoms, and R₄ represents hydrogen or a hydrocarbon group of 1 to 5 carbon atoms.

In formula (c), R₅ represents hydrogen or a hydrocarbon group of 1 to 3 carbon atoms, and R₆ represents hydrogen or a hydrocarbon group of 1 to 5 carbon atoms.

In formula (d), R₇ represents hydrogen or a hydrocarbon group of 1 to 3 carbon atoms, and R₈ represents hydrogen or a hydrocarbon group of 1 to 5 carbon atoms.

In the pressure-sensitive adhesive composition of the present invention, preferably, the ionic compound is an alkali metal salt.

In the pressure-sensitive adhesive composition of the present invention, preferably, the alkali metal salt is a lithium salt.

The pressure-sensitive adhesive composition of the present invention preferably contains 0.5 to 3 parts by weight of the ionic compound to 100 parts by weight of solid matter of the acrylic emulsion-based polymer.

The pressure-sensitive adhesive composition of the present invention preferably contains 0.01 to 10 parts by weight of the nonionic surfactant to 100 parts by weight of solid matter of the acrylic emulsion-based polymer.

The pressure-sensitive adhesive composition of the present invention preferably contains 0.2 to 1 part by weight of an ether group-containing polysiloxane to 100 parts by weight of solid matter of the acrylic emulsion-based polymer.

In the pressure-sensitive adhesive composition of the present invention, preferably, the acrylic emulsion-based polymer is a polymer obtained by polymerization using a reactive emulsifier containing a radical polymerizable functional group in the molecule.

In the pressure-sensitive adhesive composition of the present invention, preferably, the acrylic emulsion-based polymer has an average particle diameter of 130 nm to 1000 nm.

The pressure-sensitive adhesive sheet of the present invention preferably has a substrate and a pressure-sensitive adhesive layer formed by using the repeelable water-dispersible acrylic pressure-sensitive adhesive composition on at least one surface side of the substrate.

The pressure-sensitive adhesive sheet of the present invention is preferably a surface protective film for an optical member.

The pressure-sensitive adhesive composition of the present invention contains a specified acrylic emulsion-based polymer produced from raw material monomers with specified composition, a crosslinking agent, an ionic compound, and a nonionic surfactant having a specified HLB value as constituent components, and therefore the pressure-sensitive adhesive layer formed using the pressure-sensitive adhesive composition is excellent in adherability (tackiness), antistatic property, repeeling property (light peeling property), and appearance property. For this reason, the pressure-sensitive adhesive composition of the present invention is particularly useful for the purpose of surface protection of an optical film or the like.

### BRIEF DESCRIPTION OF THE DRAWING

FIG. 1 is a schematic drawing of a potential measurement part.

### DETAILED DESCRIPTION OF THE PREFERRED EMBODIMENTS

Hereinafter, embodiments of the present invention will be described in detail.

A repeelable water-dispersible acrylic pressure-sensitive adhesive composition (pressure-sensitive adhesive composition) according to the present invention is characterized by containing an acrylic emulsion-based polymer composed of 70 to 99.5% by weight of a (meth)acrylic acid alkyl ester and 0.5 to 10% by weight of a carboxyl group-containing unsaturated monomer as monomer components, a crosslinking agent, an ionic compound, and a nonionic surfactant with an HLB value of 6 or more. In addition, “water-dispersible” refers to being dispersible in an aqueous medium; that is, means a pressure-sensitive adhesive composition dispersible in an aqueous medium. The aqueous medium is a medium (dispersant) containing water as an indispensable component, and may be singly water or a mixture of water and a water-soluble organic solvent. The pressure-sensitive adhesive composition of the present invention may be a dispersion using the aqueous medium or the like.

### [Acrylic Emulsion-Based Polymer]

The acrylic emulsion-based polymer is a polymer composed of 70 to 99.5% by weight of a (meth)acrylic acid alkyl ester and 0.5 to 10% by weight of a carboxyl group-containing unsaturated monomer as raw material monomers. The acrylic emulsion-based polymers may be used singly or in combination of two or more of them. In the present invention, “(meth)acryl” refers to “acryl” and/or “methacryl”.

The (meth)acrylic acid alkyl ester is used as a main monomer component, and plays a role as a pressure-sensitive adhesive (or pressure-sensitive adhesive layer) for exhibiting basic characteristics such as mainly adherability (tackiness) and peeling property. Especially, an acrylic acid alkyl ester tends to impart flexibility to a polymer which forms a pressure-sensitive adhesive layer and to exhibit an effect of exhibiting the adhesion and adherability of the pressure-sensitive adhesive layer, and a methacrylic acid alkyl ester tends to impart hardness to a polymer which forms a pressure-sensitive adhesive layer and to exhibit an effect of adjusting the repeeling property of the pressure-sensitive adhesive layer. Examples of the (meth)acrylic acid alkyl ester include, but are not particularly limited to, (meth)acrylic acid alkyl esters having a straight chain, branched chain, or cyclic alkyl group of 1 to 16 (more preferably 2 to 10 and furthermore preferably 4 to 8) carbon atoms.

Especially, the acrylic acid alkyl ester is preferably, for example, acrylic acid alkyl esters having an alkyl group of 2 to 14 (more preferably 4 to 8) carbon atoms, and examples include acrylic acid alkyl esters having a straight chain or branched chain alkyl group such as n-butyl acrylate, isobutyl acrylate, sec-butyl acrylate, isoamylacrylate, hexylacrylate, heptyl acrylate, octyl acrylate, 2-ethylhexyl acrylate, isooctyl acrylate, nonyl acrylate, and isononyl acrylate. Among them, 2-ethylhexyl acrylate is preferable.

The methacrylic acid alkyl ester is preferably, for example, methacrylic acid alkyl esters having an alkyl group of 2 to 16 (more preferably 2 to 8) carbon atoms, and examples include methacrylic acid alkyl esters having a straight chain or branched chain alkyl group such as ethyl methacrylate, propylmethacrylate, isopropyl methacrylate, n-butyl methacrylate, isobutyl methacrylate, sec-butyl methacrylate, and tert-butyl methacrylate, and alicyclic methacrylic acid alkyl esters such as cyclohexyl methacrylate, bornyl methacrylate, and isobornyl methacrylate.

The (meth)acrylic acid alkyl esters may be properly selected in accordance with the objective adherability and may be used singly or in combination of two or more of them.

The content of the (meth)acrylic acid alkyl ester is 70 to 99.5% by weight, preferably 85 to 98% by weight, and more preferably 87 to 96% by weight in the total amount (100% by weight) of the raw material monomers (all raw material monomers) composing the acrylic emulsion-based polymer in the present invention. If the content is set to 70% by weight or more, the adherability and repeeling property of the pressure-sensitive adhesive layer are improved, and therefore it is preferable. On the other hand, if the content exceeds 99.5% by weight, the content of the carboxyl group-containing unsaturated monomer is decreased so that the appearance of the pressure-sensitive adhesive layer formed by using the pressure-sensitive adhesive composition may possibly be worsened. In the case where two or more (meth)acrylic acid alkyl esters are used, the sum (total amount) of all the (meth)acrylic acid alkyl esters should satisfy the above-mentioned range.

The carboxyl group-containing unsaturated monomer can exhibit a function of forming a protecting layer on the surfaces of emulsion particles composed of the acrylic emulsion-based polymer in the invention and preventing shear fracture of the particles. This effect can be improved further by neutralizing the carboxyl group with a base. The stability of particles against the shear fracture is more generally referred to as mechanical stability. The use of one or more kinds of crosslinking agents (in the present invention, water-insoluble crosslinking agents are preferable) reactive with the carboxyl group in combination can also provide crosslinking points in a stage of forming a pressure-sensitive adhesive layer by water removal. Further, the adhesion (anchoring property) to a substrate can be also improved through the crosslinking agent (water-insoluble crosslinking agent). Examples of the carboxyl group-containing unsaturated monomer include (meth)acrylic acids (acrylic acid and methacrylic acid), itaconic acid, maleic acid, fumaric acid, crotonic acid, carboxyethyl acrylate, and carboxypentyl acrylate. The carboxyl group-containing unsaturated monomer may also include acid anhydride group-containing unsaturated monomers such as maleic anhydride and itaconic anhydride. Among them, acrylic acid is preferable because of relatively high concentration on the surfaces of the particles and easiness to form a protecting layer with higher density.

The content of the carboxyl group-containing unsaturated monomer is 0.5 to 10% by weight, preferably 1 to 5% by weight, and more preferably 2 to 4% by weight in the total amount (100% by weight) of the raw material monomers (all raw material monomers) composing the acrylic emulsion-based polymer in the present invention. If the content is set to 10% by weight or less, an increase in interaction of the pressure-sensitive adhesive layer with a functional group existing on the surface of a polarizing plate or the like, which is an adherend (object to be protected), can be suppressed to thereby suppress an increase in peeling strength (adhesive strength) with the lapse of time, so that the peeling property (repeeling property) is improved, and therefore it is preferable. If the content exceeds 10% by weight, the carboxyl group-containing unsaturated monomer (e.g., acrylic acid) is generally water-soluble, and therefore may possibly be polymerized in water to cause an increase in viscosity (result in an increase in viscosity). Further, if a large number of carboxyl groups exist in the backbone of the acrylic emulsion-based polymer, it is assumed that interaction with the water-insoluble (hydrophobic) ionic liquid blended as an antistatic agent is caused and ion conductivity is hindered, and thus no antistatic performance to an adherend can be obtained. Accordingly, it is not preferable. On the other hand, if the content is set to 0.5% by weight or more, the mechanical stability of the emulsion particles is improved and therefore it is preferable. Further, the adhesion (anchoring property) between the pressure-sensitive adhesive layer and a substrate can be improved to thereby suppress the adhesive residue, and therefore it is preferable.

For the purpose of imparting a specified function, as the monomer components (raw material monomers) composing the acrylic emulsion-based polymer, other monomer components other than the above-mentioned indispensable components, that is the (meth)acrylic acid alkyl ester and the carboxyl group-containing unsaturated monomer, may be used in combination. For example, for the purpose of improving the cohesive strength, about 0.1 to 15% by weight of each of amide group-containing monomers such as (meth)acrylamide, N,N-diethyl(meth)acrylamide, and N-isopropyl(meth)acrylamide, and amino group-containing monomers such as N,N-dimethylaminoethyl(meth)acrylate and N,N-dimethylaminopropyl(meth)acrylate may be added (used). Further, for the purpose of adjusting the refractive index and re-working property, 15% by weight or less of each of monomers, e.g., (meth)acrylic acid aryl esters such as phenyl(meth)acrylate; vinyl esters such as vinyl acetate and vinyl propionate; and styrene-based monomers such as styrene may be added (used). Still further, for the purpose of improving the internal crosslinking among the emulsion particles and the cohesive strength, less than 5% by weight of each of epoxy group-containing monomers such as glycidyl(meth)acrylate and allyl glycidyl ether and polyfunctional monomers such as trimethylolpropane tri(meth)acrylate and divinylbenzene may be added (used). Further, for the purpose of particularly improving the low staining property by forming hydrazide crosslinking using a hydrazide-based crosslinking agent in combination, less than 10% by weight (preferably 0.5 to 5% by weight) of keto group-containing unsaturated monomers such as diacetone acrylamide (DAAM), allyl acetoacetate, and 2-(acetoacetoxy)ethyl(meth)acrylate may be added (used).

As the other monomer components, hydroxyl group-containing unsaturated monomers such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, (4-hydroxymethylcyclohexyl)methyl acrylate, N-methylol(meth)acrylamide, vinyl alcohol, allyl alcohol, 2-hydroxyethyl vinyl ether, 4-hydroxybutyl vinyl ether, and diethylene glycol monovinyl ether. From the viewpoint of lessening whitening as stain, the blend amount (use amount) of the hydroxyl group-containing unsaturated monomer is preferable small. Specifically, the blend amount of the hydroxyl group-containing unsaturated monomer is preferably lower than 1% by weight, more preferably lower than 0.1% by weight, and furthermore preferably substantially null (e.g., lower than 0.05% by weight). However, in the case where the introduction of crosslinking points for crosslinking of hydroxyl group and isocyanate group and metal crosslinking is intended, the hydroxyl group-containing unsaturated monomer may be added (used) in an amount of about 0.01 to 10% by weight.

The blend amount (use amount) of the other monomer components is the content in the total amount (100% by weight) of the raw material monomers (all raw material monomers) composing the acrylic emulsion-based polymer.

Particularly, from the viewpoint of improving the appearance of the pressure-sensitive adhesive sheet (pressure-sensitive adhesive layer) obtained by using the pressure-sensitive adhesive composition of the present invention, it is preferable to use, as the monomer component (raw material monomer) composing the acryl emulsion-based polymer, at least one monomer selected from the group consisting of methyl methacrylate, isobornyl acrylate, N,N-diethylacrylamide, and vinyl acetate (hereinafter, may be referred to as “methyl methacrylate or the like”), and particularly preferable to use methylmethacrylate. In the case of using these monomers, the stability of the emulsion particles is increased and the gel (agglomerate) can be decreased, and in the case of using a water-insoluble crosslinking agent as a crosslinking agent, the affinity to the hydrophobic water-insoluble crosslinking agent is increased to improve the dispersibility of the emulsion particles, so that the dents in the pressure-sensitive adhesive layer due to the inferior dispersion can be decreased. The content of the monomer (methyl methacrylate or the like) in the total amount (100% by weight) of the raw material monomers (all raw material monomers) composing the acrylic emulsion-based polymer is preferably 0.5 to 15% by weight, more preferably 1 to 10% by weight, and furthermore preferably 2 to 5% by weight. If the content is less than 0.5% by weight, the effect of improving the appearance may not be exhibited, and if it exceeds 15% by weight, the polymer forming the pressure-sensitive adhesive layer may be hard to lower the adhesion. In the case where two or more of monomers selected from the group consisting of methyl methacrylate, isobornyl acrylate, N,N-diethylacrylamide, and vinyl acetate are contained in the raw material monomers composing the acrylic emulsion-based polymer, the sum (total content) of methyl methacrylate, isobornyl acrylate, N,N-diethylacrylamide, and vinyl acetate should satisfy the above-mentioned range.

The acrylic emulsion-based polymer in the present invention is obtained by emulsion polymerization of the raw material monomers (monomer mixture) with the use of an emulsifier and a polymerization initiator. Further, in order to adjust the molecular weight of the acrylic emulsion-based polymer, a chain transfer agent may be used.

The acrylic emulsion-based polymer in the present invention can be obtained by emulsion polymerization of the raw material monomers (monomer mixture) with the use of an emulsifier and a polymerization initiator.

### [Reactive Emulsifier]

As the emulsifier to be used for the emulsion polymerization of the acrylic emulsion-based polymer in the present invention, it is preferable to use reactive emulsifiers having a radical polymerizable functional group introduced into the molecule (reactive emulsifiers having radical polymerizable functional groups). These reactive emulsifiers may be used singly or in combination of two or more of them.

The reactive emulsifier having a radical polymerizable functional group (hereinafter, referred to as “reactive emulsifier”) is an emulsifier having at least one radical polymerizable functional group in the molecule (one molecule). The reactive emulsifier is not particularly limited, and one or more of various reactive emulsifiers having radical polymerizable functional groups such as a vinyl group, a propenyl group, an isopropenyl group, a vinyl ether group (vinyloxy group), and an allyl ether group (allyloxy group) may be selected and used. The use of the reactive emulsifier incorporates the emulsifier into the polymer to reduce stains derived from the emulsifier, and therefore it is preferable.

Examples of the reactive emulsifier include reactive emulsifiers having a configuration (or equivalent configuration) formed by introducing a radical polymerizable functional group (radical reactive group) such as a propenyl group or an allyl ether group into a nonionic anionic emulsifier (anionic emulsifier having nonionic hydrophilic group) such as polyoxyethylene alkyl ether sodium sulfate, polyoxyethylene alkyl phenyl ether ammonium sulfate, polyoxyethylene alkyl phenyl ether sodium sulfate, and polyoxyethylene sodium alkylsulfosuccinate. Hereinafter, a reactive emulsifier having a configuration formed by introducing a radical polymerizable functional group into an anionic emulsifier is referred to as an “anionic reactive emulsifier”. A reactive emulsifier having a configuration formed by introducing a radical polymerizable functional group into a nonionic anionic emulsifier is referred to as a “nonionic anionic reactive emulsifier”.

Particularly, in the case of using an anionic reactive emulsifier (especially, nonionic anionic reactive emulsifier), the emulsifier is incorporated into the polymer to thereby be capable of improving the low staining property. Further particularly, in the case where the water-insoluble crosslinking agent of the present invention is a polyfunctional epoxy-based crosslinking agent having an epoxy group, the reactivity of the crosslinking agent can be improved due to its catalytic function. In the case where an anionic reactive emulsifier is not used, aging cannot finish the crosslinking reaction and it may result in the problem that the peeling strength (adhesive strength) of the pressure-sensitive adhesive layer is changed with the lapse of time. Still further, since the anionic reactive emulsifier is incorporated into the polymer, the anionic reactive emulsifier does not deposit on the surface of an adherend unlike a quaternary ammonium compound which is used usually as a catalyst for an epoxy-based crosslinking agent (e.g., reference to JP-A-2007-31585), and does not cause whitening as stain. Accordingly, it is preferable.

It is also possible to use, as such a reactive emulsifier, commercialized products such as trade name “Adeka Reasoap SE-10N” (manufactured by ADEKA), trade name “Aqualon HS-10” (manufactured by Dai-Ichi Kogyo Seiyaku Co., Ltd.), trade name “Aqualon HS-05” (manufactured by Dai-Ichi Kogyo Seiyaku Co., Ltd.), and trade name “Aqualon HS-102” (manufactured by Dai-Ichi Kogyo Seiyaku Co., Ltd.).

Particularly, since there may be the case where impurity ions are problematic, it is desirable to use an emulsifier from which impurity ions are removed and which has a SO₄²⁻ ion concentration of 100 μg/g or less. In the case of an anionic emulsifier, it is desirable to use an ammonium salt emulsifier. As a method for removing impurities from an emulsifier, a proper method can be used such as an ion exchange resin method, a membrane separation method, and a method for precipitation and filtration of impurities using an alcohol.

The blend amount (use amount) of the reactive emulsifier is preferably 0.1 to 10 parts by weight, more preferably 0.5 to 6 parts by weight, and furthermore preferably 1 to 4.5 parts by weight to 100 parts by weight of the total amount of the raw material monomers (all raw material monomers) composing the acrylic emulsion-based polymer in the present invention. If the blend amount is set to 0.1 parts by weight or more, stable emulsification can be maintained, and therefore it is preferable. On the other hand, if the blend amount is set to 10 parts by weight or less, the cohesive strength of the pressure-sensitive adhesive (pressure-sensitive adhesive layer) is improved, stains to an adherend can be suppressed, and stains caused by the emulsifier can be suppressed, and therefore it is preferable.

Examples of the polymerization initiator to be used for emulsion polymerization of the acrylic emulsion-based polymer is not particularly limited, and examples that can be used include azo polymerization initiators such as 2,2′-azobisisobutyronitrile, 2,2′-azobis(2-amidinopropane)dihydrochloride, 2,2′-azobis[2-(5-methyl-2-imidazolin-2-yl)propane)dihydrochloride, 2,2′-azobis(2-methylpropionamidine)disulfate, and 2,2′-azobis(N,N′-dimethyleneisobutylamidine); persulfuric acid salts such as potassium persulfate and ammonium persulfate; peroxide polymerization initiators such as benzoyl peroxide, tert-butyl hydroperoxide, and hydrogen peroxide; and redox initiators which are the combination of peroxides and reducing agents such as a combination of peroxide and ascorbic acid (combination of hydrogen peroxide and ascorbic acid, etc.), a combination of peroxide and ferrous salt (combination of hydrogen peroxide and ferrous salt), and a combination of persulfate and sodium hydrogen sulfite.

The blend amount (use amount) of the polymerization initiator is not particularly limited and can be properly determined depend on the kinds of the initiators and the raw material monomers, but is preferably 0.01 to 1 part by weight and more preferably 0.02 to 0.5 parts by weight to 100 parts by weight of the total amount of the raw material monomers (all raw material monomers) composing the acrylic emulsion-based polymer in the present invention. The blend (dropping) of the polymerization initiator is performed by collective dropping polymerization of collective dropping at once or two-stage polymerization of divisional dropping at two times, and the former is a preferable aspect since the diameter of the emulsion particle is easily controlled and it is advantageous in the antistatic property.

The emulsion polymerization of the acrylic emulsion-based polymer in the present invention can be carried out by emulsifying the monomer components in water by a conventional method and thereafter subjecting the resultant to emulsion polymerization. This makes it possible to prepare a water dispersion (polymer emulsion) containing the acrylic emulsion-based polymer as a base polymer. A method for the emulsion polymerization is not particularly limited, and examples thereof that can be employed include known emulsion polymerization methods such as a batch loading method (batch polymerization method), a monomer dropping method, and a monomer emulsion dropping method. In the monomer dropping method and the monomer emulsion dropping method, continuous dropping (collective dropping) or divisional dropping (including two-stage dropping: the divisional dropping refers to division of polymerization process by changing the dropping speed or the dropping amount, e.g., making primary dropping slow and secondary dropping fast) may be selected properly, and the continuous dropping (collective dropping) is particularly preferable. If the continuous dropping (collective dropping) is employed, the average particle diameter of the acrylic emulsion-based polymer to be used in the present invention can be adjusted to a desired range, and it is a prefer aspect. Additionally, polymerization carried out by two-step dropping may be referred to as two-stage (dropping) polymerization.

To explain the collective dropping polymerization in detail, in the case where the collective dropping polymerization is employed, an emulsifier in a sufficient amount to form micelles in the reaction system (aqueous solution containing polymerization initiator) is not present in the initial period of the dropping, and therefore no reaction is caused (in emulsion dropping polymerization, reaction is caused in the inside of emulsifier micelles), and when a certain amount of a monomer emulsion is dropped and the concentration reaches high enough to form micelles (critical micelle concentration), the particle diameter becomes large by reaction owing to a large quantity of monomer existence. Accordingly, when taking critical micelle concentration of the emulsifier into consideration, the initial loading amount of the emulsifier is controlled so that the average particle diameter can be adjusted to a desired range. These methods may be properly employed in combination. The reaction conditions or the like is selected properly, and for example, the polymerization temperature is preferably about 40 to 95° C., and the polymerization time is preferably about 30 minutes to 24 hours. Further, the average particle diameter of the acrylic emulsion-based polymer can be also adjusted by accelerate the dropping speed of the monomer emulsion or increasing the polymerization temperature.

The average particle diameter of the emulsion particles can be controlled in accordance with the kind and concentration of the emulsifier to be added at the time of polymerization, the concentration of the polymerization initiator, and the like. Herein, the average particle diameter of the emulsion particles is a numeral value of the median diameter based on volume measured by a laser diffraction/scattering particle size distribution analyzer.

Regarding the average particle diameter of the acrylic emulsion-based polymer in the present invention, the average particle diameter is preferably 130 to 1000 nm, more preferably 150 to 500 nm, and furthermore preferably 200 to 450 nm. If the average particle diameter of the acrylic emulsion-based polymer falls within the above-mentioned range, the antistatic property can be improved and thus it is advantageous.

The solvent-insoluble matter (the ratio of solvent-insoluble components, may be referred to as “gel ratio”) of the acrylic emulsion-based polymer is preferably 70% by weight (%) or more, more preferably 75% by weight or more, and furthermore preferably 80% by weight or more. If the solvent-insoluble matter is less than 70% by weight, a large quantity of low molecular weight components is contained in the acrylic emulsion-based polymer, and the low molecular weight components in the pressure-sensitive adhesive layer cannot be reduced merely by crosslinking effect, so that stains to adherend owing to the low molecular weight components may be caused or the adhesive strength may be too high. The solvent-insoluble matter can be controlled in accordance with the polymerization initiator, reaction temperature, and kinds of the emulsifier and the raw material monomers. The upper limit of the solvent-insoluble matter is not particularly limited, and for example, it is 99% by weight.

In the present invention, the solvent-insoluble matter of the acrylic emulsion-based polymer is a value calculated by the following “measurement method for solvent-insoluble matter”.

### (Measurement Method for Solvent-Insoluble Matter)

After about 0.1 g of an acrylic emulsion-based polymer is sampled and wrapped with a porous tetrafluoroethylene sheet with an average pore diameter of 0.2 μm (trade name: “NTF1122”, manufactured by Nitto Denko Corporation), the wrapped body is tied with a kite string and the weight at this time is measured as a weight before immersion. The weight before immersion is the total weight of the acrylic emulsion-based polymer (sampled above), the tetrafluoroethylene sheet, and the kite string. The total weight of the tetrafluoroethylene sheet and the kite string is also measured beforehand as a wrapping weight.

Next, the acrylic emulsion-based polymer wrapped with the tetrafluoroethylene sheet and tied with the kite string (referred to as “sample”) is put in a 50 ml container filled with ethyl acetate, and kept still at 23° C. for 7 days. Thereafter (after ethyl acetate treatment), the sample is taken out the container and transferred to an aluminum cup and dried at 130° C. for 2 hours in a drier to remove ethyl acetate, and successively, the weight is measured as a weight after immersion. The solvent-insoluble matter is calculated according to the following equation:

Solvent-insoluble matter(% by weight)=(a−b)/(c−b)×100

wherein, a is weight after immersion; b is wrapping weight; and c is weight before immersion.

The weight average molecular weight (Mw) of the solvent-soluble matter (may be referred to as “sol matter”) in the acrylic emulsion-based polymer in the present invention is preferably 40000 to 200000, more preferably 50000 to 150000, and furthermore preferably 60000 to 100000. If the weight average molecular weight of the solvent-soluble matter in the acrylic emulsion-based polymer is 40000 or more, the wettability of the pressure-sensitive adhesive composition to an adherend is improved and the tackiness to the adherend is improved. If the weight average molecular weight of the solvent-soluble matter in the acrylic emulsion-based polymer is 200000 or less, the remaining amount of the pressure-sensitive adhesive composition on the adherend is decreased and the low staining property for the adherend is improved.

The weight average molecular weight of the solvent-soluble matter in the acrylic emulsion-based polymer can be measured by subjecting to GPC (gel permeation chromatography) a sample (solvent-soluble matter in the acrylic emulsion-based polymer) obtained by air blow drying of the treated solution (ethyl acetate solution) after the ethyl acetate treatment obtained in the measurement of the solvent-insoluble matter of the acrylic emulsion-based polymer. A specific measurement method includes the following methods.

A specific method for measuring the weight average molecular weight by the GPC (gel permeation chromatography) includes the following method.

### [Measurement Method]

GPC measurement is carried out using a GPC apparatus “HLC-8220 GPC” manufactured by Tosoh Corporation, and the molecular weight is determined in terms of polystyrene. The measurement conditions are as follows.

Sample concentration: 0.2 wt % (THF solution)

Sample injection amount: 10 μl

Eluent: THF

Flow rate: 0.6 ml/min

Measuring temperature: 40° C.

Column:

Sample column; TSKguard column SuperHZ-H (1 column)+TSK gel Super HZM-H (2 columns)

Reference column; TSK gel SuperH-RC (1 column)

Detector: Refractive index detector

### [Nonionic Surfactant]

The pressure-sensitive adhesive composition of the present invention contains a nonionic surfactant with an HLB (hydrophile-lipophile-balance) value of 6 or more as an indispensable component. The HLB value means hydrophile-lipophile-balance by Griffin and is a value representing the degree of affinity of a surfactant to water or oil. The definition of the HLB value is described in W. C. Griffin: J. Soc. Cosmetic Chemists, 1, 311 (1949); Koshitami Takahashi, Yoshio Namba, Motoo Koike, and Masao Kobayashi co-authored, “Handbook of Surfactants”, 3rd ed., Kougakutosho Ltd., Nov. 25, 1972, pp. 179-182; and the like, and the ratio of hydrophilicity and lipophilicity is expressed by numeral values in a range of 0 to 20.

The HLB value of the nonionic surfactant is 6 or more, preferably 7 or more, more preferably 8 or more, and even more preferably 13 or more. Generally, the HLB value is preferably 18 or less and more preferably 17 or less. The nonionic surfactant with an HLB value of 6 or more has high hydrophilicity, that is, high polarity and therefore interacts with the ionic compound, which is an indispensable component of the pressure-sensitive adhesive composition of the present invention, to consequently exhibit an effect of unevenly distributing the ionic compound on the pressure-sensitive adhesive layer surface, so that the antistatic effect can be improved. Accordingly, it is useful. Further, the nonionic surfactant has a leveling effect and thus can contribute to an improvement in appearance of the pressure-sensitive adhesive layer surface.

The nonionic surfactant is preferable to include an acetylene structure, and more preferable to include an acetylene diol structure. If the nonionic surfactant includes an acetylene structure, especially an acetylene diol structure, the nonionic surfactant makes it possible to obtain a pressure-sensitive adhesive layer and a pressure-sensitive adhesive sheet excellent in leveling property and appearance, and therefore it is useful. Examples of the nonionic surfactant having an acetylene diol structure include an acetylene diol-based compound and/or its derivatives (hereinafter, may be referred to as “acetylene diol-based compound and the like”).

The ionic compound, which is an indispensable component in the pressure-sensitive adhesive composition of the present invention, may be difficult to be evenly mixed and dispersed at the time of dispersion in water, and the ionic compound falls into a state where the ionic compound exist unevenly sparsely and easily causes stains to an adherend; however, if the acetylene diol-based compound and the like are contained, these problems can be prevented from occurring. Further, in the case where a hydrophobic water-insoluble crosslinking agent is used, the acetylene diol-based compound can increase the affinity to the water-insoluble crosslinking agent, improve the dispersibility of the water-insoluble crosslinking agent, and lessen the dents due to the inferior dispersion. The acetylene diol-based compound and the like may be used singly or in combination of two or more of them.

The acetylene diol-based compound and the like are preferably compounds each represented by the following formula (I) or (II) and having an HLB value of 6 or more, more preferably 7 or more, furthermore preferably 8 or more, and even more preferably 13 or more. If the HLB value is within the above-mentioned range, the low staining property to an adherend is improved, and therefore it is a preferable aspect.

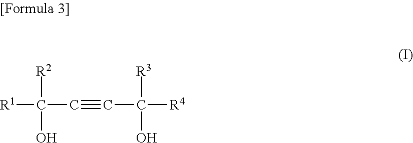

In the formula (I), R¹, R², R³, and R⁴ each represent a hydrocarbon group of 1 to 20 carbon atoms, and may be a heteroatom-containing functional group; and R¹, R², R³, and R⁴ may be the same as or different from one another.

In the formula (I), R¹, R², R³, and R⁴ each may have either a straight chain or branched chain structure. Especially, R¹ and R⁴ are each preferably an alkyl group of 2 to 10 carbon atoms, and more preferably a n-butyl group, sec-butyl group, tert-butyl group, or isobutyl group of 4 carbon atoms. R² and R³ are each preferably an alkyl group of 1 to 4 carbon atoms, and more preferably a methyl group or ethyl group of 1 or 2 carbon atoms.

Specific examples of the compound represented by the formula (I) include 7,10-dimethyl-8-hexadecin-7,10-diol, 4,7-dimethyl-5-decin-4,7-diol, 2,4,7,9-tetramethyl-5-decin-4,7-diol, and 3,6-dimethyl-4-octin-3,6-diol.

At the time of producing the pressure-sensitive adhesive composition of the present invention, when the compound represented by the formula (I) is blended, the compound may be used while being dispersed or dissolved in various kinds of solvents for the purpose of improving the blend workability. Examples of the solvent include 2-ethylhexanol, butyl cellosolve, dipropylene glycol, ethylene glycol, propylene glycol, n-propyl alcohol, and isopropanol. Among these solvents, from the viewpoint of the dispersibility in the emulsion system, ethylene glycol and propylene glycol are preferably used. The solvent content in the dispersion or solution (100% by weight) obtained by dispersing or dissolving the acetylene diol-based compound and the like in the solvent upon blending is preferably lower than 40% by weight (e.g., 15 to 35% by weight) in the case where ethylene glycol is used as the solvent, and is preferably lower than 70% by weight (e.g., 20 to 60% by weight) in the case where propylene glycol is used as the solvent.

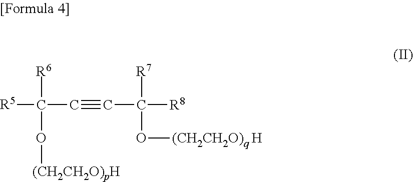

In the formula (II), R⁵, R⁶, R⁷, and R⁸ each represent a hydrocarbon group of 1 to 20 carbon atoms, and may be a heteroatom-containing functional group; and R⁵, R⁶, R⁷, and R⁸ may be the same as or different from one another. In the formula (II), p and q are each an integer of 0 or more; the sum of p and q, that is [p+q], is 1 or more, preferably 1 to 20, and more preferably 1 to 9; p and q may be the same as or different from each other; p and q are each a numeral adjusted so as to make the HLB value lower than 13; in the case where p is 0, [—O—(CH₂CH₂O)ₚH] is a hydroxyl group [—OH]; and the same shall apply to the case of q.

In the formula (II), R⁵, R⁶, R⁷, and R⁸ each may have either a straight chain or branched chain structure. Especially, R⁵ and R⁸ are each preferably an alkyl group of 2 to 10 carbon atoms, and particularly preferably a n-butyl group, sec-butyl group, tert-butyl group, or isobutyl group of 4 carbon atoms. R⁶ and R⁷ are each preferably an alkyl group of 1 to 4 carbon atoms, and particularly preferably a methyl group or ethyl group of 1 or 2 carbon atoms.

Specific examples of the compound represented by the formula (II) include an ethylene oxide adduct of 7,10-dimethyl-8-hexadecin-7,10-diol, an ethylene oxide adduct of 4,7-dimethyl-5-decin-4,7-diol, an ethylene oxide adduct of 2,4,7,9-tetramethyl-5-decin-4,7-diol, and an ethylene oxide adduct of 3,6-dimethyl-4-octin-3,6-diol. Additionally, the average addition mole number of ethylene oxide of the ethylene oxide adduct of 2,4,7,9-tetramethyl-5-decin-4,7-diol is preferably 9 or less.

At the time of producing the pressure-sensitive adhesive composition of the present invention, when the compound represented by the formula (II) (ethylene oxide-added acetylene diol-based compound and the like) is blended, the compound may be blended alone without using a solvent; however, the compound may be used while being dispersed or dissolved in various kinds of solvents for the purpose of improving the blend workability. Examples of the solvent include 2-ethylhexanol, butyl cellosolve, dipropylene glycol, ethylene glycol, propylene glycol, n-propyl alcohol, and isopropanol. Among these solvents, from the viewpoint of the dispersibility in the emulsion system, propylene glycol is preferably used. The solvent content in the dispersion or solution (100% by weight) obtained by dispersing or dissolving the acetylene diol-based compound and the like in the solvent upon blending is preferably lower than 30% by weight (e.g., 1 to 20% by weight) in the case where ethylene glycol is used as the solvent, and is preferably lower than 70% by weight (e.g., 20 to 60% by weight) in the case where propylene glycol is used as the solvent.

As the compound represented by the formula (II), commercialized products may be used and examples thereof include Surfynol 400 series manufactured by Air-Products & Chemicals, Inc. More specifically, examples include trade name “Surfynol 440” (HLB value: 8), “Surfynol 465” (HLB value: 13), and “Surfynol 485” (HLB value: 17). Further, examples include trade name “Acetylenol E 60 (HLB value: 11 to 12), “Acetylenol E 81” (HLB value: 12.2), and “Acetylenol E 100” (HLB value: 13 to 14) manufactured by Kawaken Fine Chemicals Co., Ltd. Besides those described above, the compound may be selected from trade name “Emulgen” series manufactured by Kao Corporation, trade name “Newcol” series manufactured by Nippon Nyukazai Co., Ltd., trade name “Noigen” series manufactured by Dai-Ichi Kogyo Seiyaku Co., Ltd., and the like. The acetylene diol-based compound and the like may be used singly or in combination of two or more of them.

The blend amount (use amount) of the nonionic surfactant is preferably 0.01 to 10 parts by weight, more preferably 0.1 to 8 parts by weight, and furthermore preferably 0.5 to 5 parts by weight to 100 parts by weight of the total amount of the raw material monomers (all raw material monomers) composing the acrylic emulsion-based polymer in the present invention. If the blend amount of the nonionic surfactant is set to 0.01 parts by weight or more, dispersion of the ionic liquid can be carried out evenly and stains to an adherend can be lowered, and therefore it is preferable. On the other hand, the blend amount is set to 10 parts by weight or less, bleeding of the nonionic surfactant to the pressure-sensitive adhesive layer surface can be suppressed and stains to an adherend can be prevented, and therefore it is preferable.

### [Crosslinking Agent]

The pressure-sensitive adhesive composition of the present invention contains a crosslinking agent as an indispensable component. The above-mentioned acrylic emulsion-based polymer is properly crosslinked using the crosslinking agent to give a pressure-sensitive adhesive layer (pressure-sensitive adhesive sheet) more excellent in heat resistance. Examples of the crosslinking agent to be used in the present invention include an isocyanate compound, an epoxy compound, a melamine-based resin, an aziridine derivative, and a metal chelate compound. Among them, from the viewpoint of mainly obtaining proper cohesive strength, an isocyanate compound and an epoxy compound are particularly preferably used. These compounds may be used singly or in the form of a mixture of two or more of them.

Particularly, in the present invention, a water-insoluble crosslinking agent is preferably used as the crosslinking agent. The water-insoluble crosslinking agent is a water-insoluble compound, which is a compound having 2 or more (e.g., 2 to 6) functional groups capable of reacting with a carboxyl group in the molecule (in one molecule). The number of the functional groups capable of reacting with a carboxyl group in one molecule is more preferably 3 to 5. As the number of the functional groups capable of reacting with a carboxyl group in one molecule is higher, the pressure-sensitive adhesive composition is more densely crosslinked (that is, the crosslinked structure of a polymer forming the pressure-sensitive adhesive layer becomes dense). For this reason, the wet spreading of the pressure-sensitive adhesive layer after the pressure-sensitive adhesive layer formation can be prevented. Further, the polymer forming the pressure-sensitive adhesive layer is restrained so that the functional groups (carboxyl groups) in the pressure-sensitive adhesive layer exist unevenly on the adherend surface, and thus an increase in peeling strength (adhesive strength) between the pressure-sensitive adhesive layer and the adherend with the lapse of time can be prevented. On the other hand, in the case where the number of the functional groups capable of reacting with a carboxyl group in one molecule is too high beyond 6, a gelling compound may be formed.

Examples of the functional group of the water-insoluble crosslinking agent in the present invention, the functional group being capable of reacting with a carboxyl group, include, but are not particularly limited to, an epoxy group, an isocyanate group, and a carbodiimide group. Especially, from the viewpoint of reactivity, an epoxy group is preferable. Further, from the viewpoint of an advantage in less residues of unreacted substances and low staining property at the time of crosslinking reaction owing to high reactivity, and also from the viewpoint of capability of preventing an increase in peeling strength (adhesive strength) between the pressure-sensitive adhesive layer and the adherend with the lapse of time owing to the unreacted carboxyl groups in the pressure-sensitive adhesive layer, a glycidylamino group is preferable. That is, as the water-insoluble crosslinking agent in the present invention, epoxy-based crosslinking agents containing epoxy group are preferable, and especially, a glycidylamino group-containing crosslinking agent (glycidylamino-based crosslinking agent) is preferable. In the case where the water-insoluble crosslinking agent in the present invention is an epoxy-based crosslinking agent (particularly, a glycidylamino-based crosslinking agent), the number of epoxy groups (particularly, glycidylamino groups) in one molecule is 2 or more (e.g., 2 to 6), and preferably 3 to 5.

The water-insoluble crosslinking agent in the invention is a water-insoluble compound. Herein, “water-insoluble” means the solubility (weight of compound (crosslinking agent) soluble in 100 parts by weight of water) of 5 parts by weight or less, preferably 3 parts by weight or less, and more preferably 2 parts by weight or less at 25° C. in 100 parts by weight of water. If the water-insoluble crosslinking agent is used, the low staining property is improved since the crosslinking agent remaining without being crosslinked hardly causes whitening as stain on an adherend under highly humid environments. In the case of a water-soluble crosslinking agent, the remaining crosslinking agent is dissolved in water and tends to be transferred easily to an adherend under highly humid environments, and therefore the water-soluble crosslinking agent tends to cause whitening as stain. Further, as compared with the water-soluble crosslinking agent, the water-insoluble crosslinking agent highly contributes to crosslinking reaction (reaction with carboxyl group) and highly effectively prevents an increase in peeling strength (adhesive strength) with the lapse of time. Further, the water-insoluble crosslinking agent has high reactivity in crosslinking reaction, and therefore the water-insoluble crosslinking agent quickly promotes crosslinking reaction by aging to prevent an increase in peeling strength (adhesive strength) between the pressure-sensitive adhesive layer and the adherend with the lapse of time owing to the unreacted carboxyl group in the pressure-sensitive adhesive layer.

The solubility of the crosslinking agent in water can be measured as follows.

### [Method for Measuring Solubility in Water]

Water (25° C.) and a crosslinking agent in the same weight are mixed by a stirrer at a rotation speed of 300 rpm for 10 minutes, and separated into a water phase and an oil phase by centrifugation. Next, the water phase is sampled and dried at 120° C. for 1 hour, and the non-volatile matter in the water phase is measured based on the drying weight loss (part by weight of non-volatile matter to 100 parts by weight of water).

Specifically, examples of the water-insoluble crosslinking agent in the present invention include glycidylamino-based crosslinking agents such as 1,3-bis(N,N-diglycidylaminomethyl)cyclohexane (e.g., trade name “TETRAD-C”, manufactured by Mitsubishi Gas Chemical Company, Inc., etc.) [solubility of 2 parts by weight or less to 100 parts by weight of water at 25° C.] and 1,3-bis(N,N-diglycidylaminomethyl)benzene (e.g., trade name “TETRAD-X”, manufactured by Mitsubishi Gas Chemical Company, Inc., etc.) (solubility of 2 parts by weight or less to 100 parts by weight of water at 25° C.); and other epoxy-based crosslinking agents such as Tris(2,3-epoxypropyl) isocyanurate (e.g., trade name: “TEPIC-G”, manufactured by Nissan Chemical Industries, Ltd., etc.) [solubility of 2 parts by weight or less to 100 parts by weight of water at 25° C.]

The blend amount of the crosslinking agent (water-insoluble crosslinking agent) in the present invention (content in the pressure-sensitive adhesive composition of the present invention) is preferable to be a blend amount for adjusting the number of moles of the functional group of the water-insoluble crosslinking agent in the present invention, the functional group being capable of reacting with a carboxyl group, to 0.2 to 1.3 moles to 1 mole of the carboxyl group of the carboxyl group-containing unsaturated monomer to be used as a raw material monomer for the acrylic emulsion-based polymer in the present invention. Specifically, the ratio of “total number of moles of the functional group of all the water-insoluble crosslinking agent in the present invention, the functional group being capable of reacting with a carboxyl group” to “total number of moles of the carboxyl group of all the carboxyl group-containing unsaturated monomer to be used as a raw material monomer for the acrylic emulsion-based polymer in the present invention”, that is, [functional group capable of reacting with carboxyl group/carboxyl group] (mole ratio), is preferably 0.2 to 1.3, more preferably 0.3 to 1.1, and furthermore preferably 0.5 to 1.0. If the [functional group capable of reacting with carboxyl group/carboxyl group] is set to 0.2 or more, the unreacted carboxyl groups in the pressure-sensitive adhesive layer can be reduced and an increase in peeling strength (adhesive strength) with the lapse of time attributed to the interaction between the carboxyl group and the adherend can be effectively prevented, and therefore it is preferable. If it is set to 1.3 or less, the unreacted water-insoluble crosslinking agent in the pressure-sensitive adhesive layer can be reduced, appearance deterioration by the water-insoluble crosslinking agent can be suppressed, and the appearance property can be improved, and therefore it is preferable.

Particularly, in the case where the water-insoluble crosslinking agent in the present invention is an epoxy-based crosslinking agent, [epoxy group/carboxyl group] (mole ratio) is preferably 0.2 to 1.3, more preferably 0.3 to 1.1, and furthermore preferably 0.5 to 1.0. In the case where the water-insoluble crosslinking agent in the present invention is a glycidylamino-based crosslinking agent, [glycidylamine group/carboxyl group] (mole ratio) is preferable to satisfy the above-mentioned range.

For example, in the case where 4 g of a water-insoluble crosslinking agent with a functional group equivalent of 110 (g/eq) of the functional group capable of reacting with a carboxyl group is added (blended) in a water-dispersible acrylic pressure-sensitive adhesive composition (pressure-sensitive adhesive composition), the number of moles of the functional group included in the water-insoluble crosslinking agent, the functional group being capable of reacting with a carboxyl group, can be calculated as follows.

[Number of moles of functional group included in water-insoluble crosslinking agent, the functional group being capable of reacting with carboxyl group]=[blend amount of water-insoluble crosslinking agent(blend amount)]/[functional group equivalent]=4/110.

For example, in the case where 4 g of an epoxy-based crosslinking agent with an epoxy equivalent of 110 (g/eq) is added (blended) as a water-insoluble crosslinking agent, the number of moles of epoxy in the epoxy type crosslinking agent is calculated as follows.

Number of moles of functional group of water-insoluble crosslinking agent reactive on carboxyl=[addition amount (addition amount) of epoxy type crosslinking agent]/[epoxy equivalent]=4/110.

### [Ionic Compound]

The pressure-sensitive adhesive composition of the present invention contains an ionic compound as an indispensable component. The ionic compound is not particularly limited and is preferable to contain a fluorine atom-containing anion, a nitrogen atom-containing anion, and a sulfonyl group-containing anion and more preferable to be an ionic liquid and/or an alkali metal salt. If these ionic compounds are contained, an excellent antistatic property can be imparted.

From the viewpoint of antistatic property, the use of the ionic liquid as the ionic compound can give a pressure-sensitive adhesive layer with high antistatic effect without deteriorating adherability. The reason why the use of the ionic liquid can give an excellent antistatic effect is not made clear in detail; however, it is supposed that since the ionic liquid is in a liquid state, the molecular motion is easy and thus excellent antistatic performance is obtained. Particularly, in the case of preventing electrification to an adherend, it is supposed that a trace amount of the ionic liquid is transferred to an adherend, and accordingly, excellent peeling electrification prevention to an adherend is exhibited.

Further, the ionic liquid is in a liquid state at room temperature (25° C.), and therefore it can be added and then dispersed or dissolved easily in a pressure-sensitive adhesive as compared with a solid salt. Further, the ionic liquid has no vapor pressure (no volatility), and therefore it is not lost with the lapse of time and thus continuously gives the antistatic property. The ionic liquid refers to a molten salt (ionic compound) exhibiting a liquid state at room temperature (25° C.).

As the ionic liquid, those composed of an organic cationic component represented by the following formulas (A) to (E) and an anionic component are preferably used. Ionic liquids having these cations give further excellent antistatic performance.

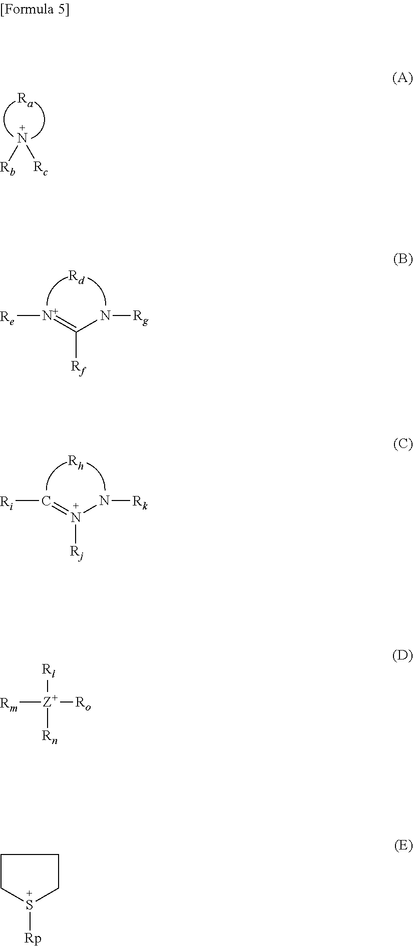

In formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent.

In formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group.

In formula (C), Rₕ represents a hydrocarbon group of 2 to 20 carbon atoms, part of the hydrocarbon group may be a heteroatom-substituted functional group, Rᵢ, Rⱼ, and Rₖ are the same or different and each represent hydrogen or a hydrocarbon group of 1 to 16 carbon atoms, and part of the hydrocarbon group may be a heteroatom-substituted functional group.

In formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent.

In formula (E), Rₚ represents a hydrocarbon group of 1 to 18 carbon atoms, and part of the hydrocarbon group may be a heteroatom-substituted functional group.

Examples of the cation represented by the formula (A) include a pyridinium cation, a piperidinium cation, a pyrrolidinium cation, a cation having a pyrroline skeleton, a cation having a pyrrole skeleton, and a morpholinium cation.

Specific examples include a 1-ethylpyridinium cation, a 1-butylpyridinium cation, a 1-hexylpyridinium cation, a 1-butyl-3-methylpyridinium cation, a 1-butyl-4-methylpyridinium cation, a 1-hexyl-3-methylpyridinium cation, a 1-butyl-3,4-dimethylpyridinium cation, a 1,1-dimethylpyrrolidinium cation, a 1-ethyl-1-methylpyrrolidinium cation, a 1-methyl-1-propylpyrrolidinium cation, a 1-methyl-1-butylpyrrolidinium cation, a 1-methyl-1-pentylpyrrolidinium cation, a 1-methyl-1-hexylpyrrolidinium cation, a 1-methyl-1-heptylpyrrolidinium cation, a 1-ethyl-1-propylpyrrolidinium cation, a 1-ethyl-1-butylpyrrolidinium cation, a 1-ethyl-1-pentylpyrrolidinium cation, a 1-ethyl-1-hexylpyrrolidinium cation, a 1-ethyl-1-heptylpyrrolidinium cation, a 1,1-dipropylpyrrolidinium cation, a 1-propyl-1-butylpyrrolidinium cation, a 1,1-dibutylpyrrolidinium cation, a pyrrolidinium-2-one cation, a 1-propylpiperidinium cation, a 1-pentylpiperidinium cation, a 1,1-dimethylpiperidinium cation, a 1-methyl-1-ethylpiperidinium cation, a 1-methyl-1-propylpiperidinium cation, a 1-methyl-1-butylpiperidinium cation, a 1-methyl-1-pentylpiperidinium cation, a 1-methyl-1-hexylpiperidinium cation, a 1-methyl-1-heptylpiperidinium cation, a 1-ethyl-1-propylpiperidinium cation, a 1-ethyl-1-butylpiperidinium cation, a 1-ethyl-1-pentylpiperidinium cation, a 1-ethyl-1-hexylpiperidinium cation, a 1-ethyl-1-heptylpiperidinium cation, a 1,1-dipropylpiperidinium cation, a 1-propyl-1-butylpiperidinium cation, a 1,1-dibutylpiperidinium cation, a 2-methyl-1-pyrroline cation, a 1-ethyl-2-phenylindole cation, a 1,2-dimethylindole cation, a 1-ethylcarbazole cation, and a N-ethyl-N-methylmorpholinium cation.

Examples of the cation represented by the formula (B) include an imidazolium cation, a tetrahydropyrimidinium cation, and a dihydropyrimidinium cation.

Specific examples include a 1,3-dimethylimidazolium cation, a 1,3-diethylimidazolium cation, a 1-ethyl-3-methylimidazolium cation, a 1-butyl-3-methylimidazolium cation, a 1-hexyl-3-methylimidazolium cation, a 1-octyl-3-methylimidazolium cation, a 1-decyl-3-methylimidazolium cation, a 1-dodecyl-3-methylimidazolium cation, a 1-tetradecyl-3-methylimidazolium cation, a 1,2-dimethyl-3-propylimidazolium cation, a 1-ethyl-2,3-dimethylimidazolium cation, a 1-butyl-2,3-dimethylimidazolium cation, a 1-hexyl-2,3-dimethylimidazolium cation, a 1-(2-methoxyethyl)-3-methylimidazolium cation, a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, and a 1,2,3,4-tetramethyl-1,6-dihydropyrimidinium cation.

Examples of the cation represented by the formula (C) include a pyrazolium cation, and a pyrazolinium cation.

Specific examples include a 1-methylpyrazolium cation, a 3-methylpyrazolium cation, a 1-ethyl-2-methylpyrazolium cation, a 1-ethyl-2,3,5-trimethylpyrazolium cation, a 1-propyl-2,3,5-trimethylpyrazolium cation, a 1-butyl-2,3,5-trimethylpyrazolium cation, a 1-ethyl-2,3,5-trimethylpyrazolium cation, a 1-propyl-2,3,5-trimethylpyrazolium cation, and a 1-butyl-2,3,5-trimethylpyrazolium cation.

Examples of the cation represented by the formula (D) include a tetraalkylammonium cation, a trialkylsulfonium cation, a tetraalkylphosphonium cation, and those obtained by substituting part of the alkyl groups with an alkenyl group, an alkoxy group, a hydroxyl group, a cyano group, and an epoxy group.

Specific examples include a tetramethylammonium cation, a tetraethylammonium cation, a tetrabutylammonium cation, a tetrapentylammonium cation, a tetrahexylammonium cation, a tetraheptylammonium cation, a triethylmethylammonium cation, a tributylethylammonium cation, a trimethyldecylammonium cation, a N,N-diethyl-N-methyl-N-(2-methoxyethyl)ammonium cation, a glycidyltrimethylammonium cation, a trimethylsulfonium cation, a triethylsulfonium cation, a tributylsulfonium cation, a trihexylsulfonium cation, a diethylmethylsulfonium cation, a dibutylethylsulfonium cation, a dimethyldecylsulfonium cation, a tetramethylphosphonium cation, a tetraethylphosphonium cation, a tetrabutylphosphonium cation, a tetrahexylphosphonium cation, a tetraoctylphosphonium cation, a triethylmethylphosphonium cation, a tributylethylphosphonium cation, a trimethyldecylphosphonium cation, a diallyldimethylammonium cation, and a tributyl(2-methoxyethyl)phosphonium cation. Among them, preferably used are asymmetric tetraalkylammonium cations such as a triethylmethylammonium cation, a tributylethylammonium cation, a trimethyldecylammonium cation, a diethylmethylsulfonium cation, a dibutylethylsulfonium cation, a dimethyldecylsulfonium cation, a triethylmethylphosphonium cation, a tributylethylphosphonium cation, and a trimethyldecylphosphonium; and a trialkylsulfonium cation, a tetraalkylphosphonium cation, a N,N-diethyl-N-methyl-N-(2-methoxyethyl)ammonium cation, a glycidyltrimethylammonium cation, a diallyldimethylammonium cation, a N,N-dimethyl-N-ethyl-N-propylammonium cation, a N,N-dimethyl-N-ethyl-N-butylammonium cation, a N,N-dimethyl-N-ethyl-N-pentylammonium cation, a N,N-dimethyl-N-ethyl-N-hexylammonium cation, a N,N-dimethyl-N-ethyl-N-heptylammonium cation, a N,N-dimethyl-N-ethyl-N-nonylammonium cation, a N,N-dimethyl-N,N-dipropylammonium cation, a N,N-diethyl-N-propyl-N-butylammonium cation, a N,N-dimethyl-N-propyl-N-pentylammonium cation, a N,N-dimethyl-N-propyl-N-hexylammonium cation, a N,N-dimethyl-N-propyl-N-heptylammonium cation, a N,N-dimethyl-N-butyl-N-hexylammonium cation, a N,N-diethyl-N-butyl-N-heptylammonium cation, a N,N-dimethyl-N-pentyl-N-hexylammonium cation, a N,N-dimethyl-N,N-dihexylammonium cation, a trimethylheptylammonium cation, a N,N-diethyl-N-methyl-N-propylammonium cation, a N,N-diethyl-N-methyl-N-pentylammonium cation, a N,N-diethyl-N-methyl-N-heptylammonium cation, a N,N-diethyl-N-propyl-N-pentylammonium cation, a triethylpropylammonium cation, a triethylpentylammonium cation, a triethylheptylammonium cation, a N,N-dipropyl-N-methyl-N-ethylammonium cation, a N,N-dipropyl-N-methyl-N-pentylammonium cation, a N,N-dipropyl-N-butyl-N-hexylammonium cation, a N,N-dipropyl-N,N-dihexylammonium cation, a N,N-dibutyl-N-methyl-N-pentylammonium cation, a N,N-dibutyl-N-methyl-N-hexylammonium cation, a trioctylmethylammonium cation, and a N-methyl-N-ethyl-N-propyl-N-pentylammonium cation.

The cation represented by the formula (E) includes, for example, a sulfonium cation. Specific examples of Rp in the formula (E) include a methyl group, an ethyl group, a propyl group, a butyl group, a hexyl group, an octyl group, a nonyl group, a decyl group, a dodecyl group, a tridecyl group, a tetradecyl group, an octadecyl group and the like.

The ionic liquid is preferable to contain at least one cation selected from the group consisting of cations represented by the following formulas (a) to (d). These cations are included in the formulas (A) and (B).

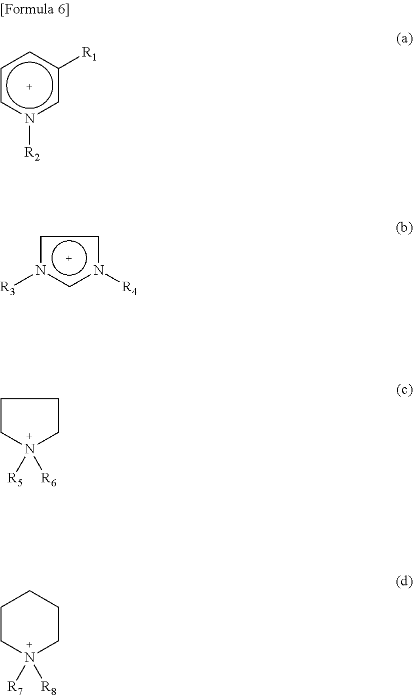

In formula (a), R₁ represents hydrogen or a hydrocarbon group of 1 to 3 carbon atoms, and R₂ represents hydrogen or a hydrocarbon group of 1 to 5 carbon atoms.

In formula (b), R₃ represents hydrogen or a hydrocarbon group of 1 to 3 carbon atoms, and R₄ represents hydrogen or a hydrocarbon group of 1 to 5 carbon atoms.

In formula (c), R₅ represents hydrogen or a hydrocarbon group of 1 to 3 carbon atoms, and R₆ represents hydrogen or a hydrocarbon group of 1 to 5 carbon atoms.

In formula (d), R₇ represents hydrogen or a hydrocarbon group of 1 to 3 carbon atoms, and R₈ represents hydrogen or a hydrocarbon group of 1 to 5 carbon atoms.

On the other hand, an anion component is not particularly limited if it is satisfactory to give an ionic liquid, and examples to be used include Cl⁻, Br⁻, I⁻, AlCl₄⁻, Al₂Cl₇⁻, BF₄⁻, PF₆⁻, ClO₄⁻, NO₃⁻, CH₃COO⁻, CF₃COO⁻, CH₃SO₃⁻, (CF₃SO₂)₂N⁻, (C₃F₇SO₂)₂N⁻, (C₄F₉SO₂)₂N⁻, (CF₃SO₂)₃C⁻, AsF₆⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂)(CF₃CO)N⁻, C₉H₁₉COO⁻, (CH₃)₂PO₄⁻, (C₂H₅)₂PO₄⁻, C₂H₅OSO₃⁻, C₆H₁₃OSO₃⁻, C₈H₁₇OSO₃⁻, CH₃ (OC₂H₄)₂OSO₃⁻, C₆H₄(CH₃)SO₃⁻, (C₂F₅)₃PF₃⁻, CH₃CH(OH)COO⁻, and (FSO₂)₂N⁻. Especially, fluorine atom-containing anion components give anionic compound with a low melting point, and therefore they are preferably used. Further, many of nitrogen atom-containing anion components give hydrophobicity, are not dissociated even if added to a water-dispersible pressure-sensitive adhesive, and scarcely generate agglomerates, and therefore they are preferably used. Still further, sulfonyl-containing anion components are excellent in stability in water, electric conductivity, and heat stability, and therefore they are preferably used.

It is also possible to use, as an anion component, an anion represented by the following formula (F).

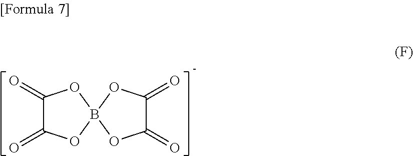

Specific examples of the ionic liquid to be used in the present invention are those properly selected from combinations of the cation components and the anion components, and include 1-butylpyridinium tetrafluoroborate, 1-butylpyridinium hexafluorophosphate, 1-butyl-3-methylpyridinium tetrafluoroborate, 1-butyl-3-methylpyridinium trifluoromethanesulfonate, 1-butyl-3-methylpyridinium bis(trifluoromethanesulfonyl)imide, 1-butyl-3-methylpyridinium bis(pentafluoroethanesulfonyl)imide, 1-hexylpyridinium tetrafluoroborate, 1,1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dimethylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-dipropylpiperidinium bis(trifluoromethanesulfonyl)imide, 1-propyl-1-butylpiperidinium bis(trifluoromethanesulfonyl)imide, 1,1-dibutylpiperidinium bis(trifluoromethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1-ethyl-1-propylpiperidinium bis(pentafluoroethanesulfonyl)imide, 1-ethyl-1-butylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1,1-dipropylpiperidinium bis(pentafluoroethanesulfonyl)imide, 1-propyl-1-butylpiperidinium bis(pentafluoroethanesulfonyl)imide, 1,1-dibutylpiperidinium bis(pentafluoroethanesulfonyl)imide, 2-methyl-1-pyrroline tetrafluoroborate, 1-ethyl-2-phenylindoletetrafluoroborate, 1,2-dimethylindole tetrafluoroborate, 1-ethylcarbazole tetrafluoroborate, 1-ethyl-3-methylimidazolium tetrafluoroborate, 1-ethyl-3-methylimidazolium acetate, 1-ethyl-3-methylimidazolium trifluoroacetate, 1-ethyl-3-methylimidazolium heptafluorobutyrate, 1-ethyl-3-methylimidazolium trifluoromethanesulfonate, 1-ethyl-3-methylimidazolium perfluorobutanesulfonate, 1-ethyl-3-methylimidazolium dicyanamide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl)methide, 1-butyl-3-methylimidazolium tetrafluoroborate, 1-butyl-3-methylimidazolium hexafluorophosphate, 1-butyl-3-methylimidazolium trifluoroacetate, 1-butyl-3-methylimidazolium heptafluorobutyrate, 1-butyl-3-methylimidazolium trifluoromethanesulfonate, 1-butyl-3-methylimidazolium perfluorobutanesulfonate, 1-butyl-3-methylimidazolium bis(trifluoromethanesulfonyl)imide, 1-hexyl-3-methylimidazolium bromide, 1-hexyl-3-methylimidazolium chloride, 1-hexyl-3-methylimidazolium tetrafluoroborate, 1-hexyl-3-methylimidazolium hexafluorophosphate, 1-hexyl-3-methylimidazolium trifluoromethanesulfonate, 1-octyl-3-methylimidazolium tetrafluoroborate, 1-octyl-3-methylimidazolium hexafluorophosphate, 1-hexyl-2,3-dimethylimidazolium tetrafluoroborate, 1,2-dimethyl-3-propylimidazolium bis(trifluoromethanesulfonyl)imide, 1-methylpyrazolium tetrafluoroborate, 2-methylpyrazolium tetrafluoroborate, 1-ethyl-2,3,5-trimethylpyrazolium bis(trifluoromethanesulfonyl)imide, 1-propyl-2,3,5-trimethylpyrazolium bis(trifluoromethanesulfonyl)imide, 1-butyl-2,3,5-trimethylpyrazolium bis(trifluoromethanesulfonyl)imide, 1-ethyl-2,3,5-trimethylpyrazolium bis(pentafluoroethanesulfonyl)imide, 1-propyl-2,3,5-trimethylpyrazolium bis(pentafluoroethanesulfonyl)imide, 1-butyl-2,3,5-trimethylpyrazolium bis(pentafluoroethanesulfonyl)imide, 1-ethyl-2,3,5-trimethylpyrazolium bis(trifluoromethanesulfonyl)trifluoroacetamide, 1-propyl-2,3,5-trimethylpyrazolium bis(trifluoromethanesulfonyl)trifluoroacetamide, 1-butyl-2,3,5-trimethylpyrazolium bis(trifluoromethanesulfonyl)trifluoroacetamide, 1-ethyl-2,3,5-trimethylpyrazolinium bis(trifluoromethanesulfonyl)imide, 1-propyl-2,3,5-trimethylpyrazolinium bis(trifluoromethanesulfonyl)imide, 1-butyl-2,3,5-trimethylpyrazolinium bis(trifluoromethanesulfonyl)imide, 1-ethyl-2,3,5-trimethylpyrazolinium bis(pentafluoroethanesulfonyl)imide, 1-propyl-2,3,5-trimethylpyrazolinium bis(pentafluoroethanesulfonyl)imide, 1-butyl-2,3,5-trimethylpyrazolinium bis(pentafluoroethanesulfonyl)imide, 1-ethyl-2,3,5-trimethylpyrazolinium bis(trifluoromethanesulfonyl)trifluoroacetamide, 1-propyl-2,3,5-trimethylpyrazolinium bis(trifluoromethanesulfonyl)trifluoroacetamide, 1-butyl-2,3,5-trimethylpyrazolinium bis(trifluoromethanesulfonyl)trifluoroacetamide, tetrapentylammonium trifluoromethanesulfonate, tetrapentylammonium bis(trifluoromethanesulfonyl)imide, tetrahexylammonium trifluoromethanesulfonate, tetrahexylammonium bis(trifluoromethanesulfonyl)imide, tetraheptylammonium trifluoromethanesulfonate, tetraheptylammonium bis(trifluoromethanesulfonyl)imide, diallyldimethylammonium tetrafluoroborate, diallyldimethylammonium trifluoromethanesulfonate, diallyldimethylammonium bis(trifluoromethanesulfonyl)imide, diallyldimethylammonium bis(pentafluoroethanesulfonyl)imide, N,N-diethyl-N-methyl-N-(2-methoxyethyl)ammonium tetrafluoroborate, N,N-diethyl-N-methyl-N-(2-methoxyethyl)ammonium trifluoromethanesulfonate, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyltrimethylammonium trifluoromethanesulfonate, glycidyltrimethylammonium bis(trifluoromethanesulfonyl)imide, glycidyltrimethylammonium bis(pentafluoroethanesulfonyl)imide, tetraoctylphosphonium trifluoromethanesulfonate, tetraoctylphosphonium bis(trifluoromethanesulfonyl)imide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, 1-butylpyridinium(trifluoromethanesulfonyl)trifluoroacetamide, 1-butyl-3-methyl pyridinium(trifluoromethanesulfonyl)trifluoroacetamide, 1-ethyl-3-methylimidazolium (trifluoromethanesulfonyl)trifluoroacetamide, N-ethyl-N-methylmorpholinium thiocyanate, 4-ethyl-4-methylmorpholinium methylcarbonate, 1-ethyl-3-methylimidazolium thiocyanate, 1-butyl-3-methylimidazolium thiocyanate, 1-ethyl-3-methylimidazolium tetracyanoborate, 1-ethyl-3-methylimidazolium tris(pentafluoroethyl)trifluorophosphate, 1-ethyl-3-methylimidazolium bis(fluorosulfonyl)imide, and triethylsulfonium bis(trifluoromethylsulfonyl)imide.

As the aforementioned ionic liquid, a commercially available ionic liquid may be used, or the liquid may be synthesized as described below. A method of synthesizing an ionic liquid is not particularly limited as far as an objective ionic liquid is obtained. Generally, a halide method, a hydroxide method, an acid ester method, a chelate forming method, and a neutralization method described in the publication “Ionic liquid—The Front and Future of Development—” (published by CMC) are used.

Regarding a halide method, a hydroxide method, an acid ester method, a chelate forming method, and a neutralization method, a synthesis method using an example of a nitrogen-containing onium salt will be shown below, but other ionic liquid such as a sulfur-containing onium salt, and a phosphorus-containing onium salt can be obtained by the similar procedure.

The halide method is a method which is performed by a reaction shown in the following formulas (1) to (3). First, a tertiary amine and alkyl halide are reacted to obtain halide (Reaction Equation (1), as a halogen, chlorine, bromine or iodine is used). The resulting halide is reacted with an acid (HA) having an anion structure (A⁻) of an objective ionic liquid or a salt (MA, M is a cation forming a salt with an objective anion such as ammonium, lithium, sodium and potassium) of an objective ionic liquid to obtain an objective ionic liquid (R₄NA).

[Formula 8]

R₃N+RX→R₄NX (X: Cl, Br, I) (1)

R₄NX+HA→R₄NA+HX (2)

R₄NX+MA→R₄NA+MX (M: NH₄, Li, Na, K, Ag etc.) (3)

The hydroxide method is a method performed by a reaction shown in (4) to (8). First, a halide (R₄NX) is subjected to ion exchange membrane method electrolysis (reaction equation (4)), an OH-type ion exchange resin method (reaction equation (5)) or a reaction with silver oxide (Ag₂O) (reaction equation (6)) to obtain a hydroxide (R₄NOH) (as a halogen, chlorine, bromine or iodine is used).

The resulting hydroxide is subjected to a reaction of reaction equations (7) to (8) as in the aforementioned halide method to obtain an objective ionic liquid (R₄NA).

[Formula 9]

R₄NX+H₂O→R₄NOH+½H₂+½X₂ (X: Cl, Br, I) (4)

R₄NX+P—OH→R₄NOH+P—X (P—OH: OH-type ion exchange resin) (5)

R₄NX+½Ag₂O+½H₂O→R₄NOH+AgX (6)

R₄NOH+HA→R₄NA+H₂O (7)

R₄NOH+MA→R₄NA+MOH (M: NH₄, Li, Na, K, Ag etc.) (8)

The acid ester method is a method performed by a reaction shown in (9) to (11). First, tertiary amine (R₃N) is reacted with acid ester to obtain an acid esterified substance (reaction equation (9), as acid ester, ester of an inorganic acid such as sulfuric acid, sulfurous acid, phosphoric acid, phosphorous acid, and carbonic acid, or ester of organic acid such as methanesulfonic acid, methylphosphonic acid and formic acid is used). The resulting acid esterified substance is subjected to a reaction of reaction equations (10) to (11) as in the aforementioned halide method, to obtain an objective ionic liquid (R₄NA). Alternatively, as acid ester, methyl trifluoromethane sulfonate, or methyl trifluoroacetate may be used to directly obtain an ionic liquid.

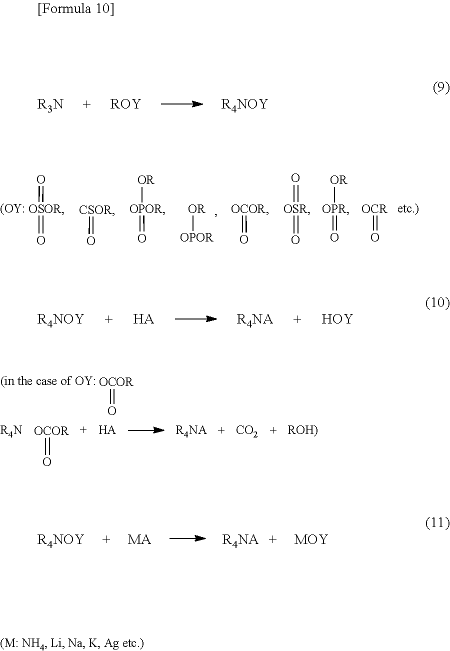

The chelate forming method is a method performed by a reaction as shown in (12) to (15). First, halide of quaternary ammonium (R₄NX), hydroxide of quaternary ammonium (R₄NOH), or carbonic acid esterified substance of quaternary ammonium (R₄NOCO₂CH₃) is reacted with hydrogen fluoride (HF) or ammonium fluoride (NH₄F) to obtain a quaternary ammonium fluoride salt (reaction equation (12) to (14)). The resulting quaternary ammonium fluoride salt can be subjected to a chelate forming reaction with fluoride such as BF₃, AlF₃, PF₅, ASF₅, SbF₅, NbF₅ and TaF₆, to obtain an ionic liquid (reaction equation (15)).

[Formula 11]

R₄NX+HF→R₄NF+HX (X: Cl, Br, I) (12)

R₄NY+HF→R₄NF+HY (Y: OH, OCO₂CH₃) (13)

R₄NY+NH₄F→R₄NF+NH₃+HY (Y: OH, OCO₂CH₃) (14)

R₄NF+MFₙ₋₁→R₄NMFₙ (15)

### (MFₙ₋₁: BF₃, AlF₃, PF₅, ASF₅, SbF₅, NbF₅, TaF₅ etc.)

The neutralization method is a method performed by a reaction shown in (16). An ionic liquid can be obtained by reacting tertiary amine and an organic acid such as HBF₄, HPF₆, CH₃COOH, CF₃COOH, CF₃SO₃H, (CF₃SO₂)₂NH, (CF₃SO₂)₃CH, and (C₂F₅SO₂)₂NH.

[Formula 12]

R₃N+HZ→R₃HN⁺Z⁻ (16)

[HZ: HBF₄, HPF₆, CH₃COOH, CF₃COOH, CF₃SO₃H, (CF₃SO₂)₂NH, (CF₃SO₂)₃CH, (C₂F₅SO₂)₂NH organic acid such as]

In the formulas (1) to (16), R represents hydrogen or a hydrocarbon group of 1 to 20 carbon atoms, and a portion of the hydrocarbon group may be substituted with a heteroatom to form a functional group.

The alkali metal salt has high ion dissociation, and therefore it is preferable in terms of exhibiting excellent antistatic performance even if the addition amount is very small. The alkali metal salt to be used preferably are alkali metal salts each composed of a cation such as Li⁺, Na⁺, or K⁺ and an anion such as Cl⁻, Br⁻, I⁻, AlCl₄⁻, Al₂Cl₇⁻, BF₄⁻, PF₆⁻, SCN⁻, ClO₄⁻, NO₃⁻, CH₃COO⁻, C₉H₁₉COO⁻, CF₃COO⁻, C₃F₇COO⁻, CH₃SO₃⁻, CF₃SO₃⁻, C₄F₉SO₃⁻, C₂H₅OSO₃⁻, C₆H₁₃OSO₃⁻, C₈H₁₇OSO₃⁻, (CF₃SO₂)₂N⁻, (C₂F₅SO₂)₂N⁻, (C₃F₇SO₂)₂N⁻, (C₄F₉SO₂)₂N⁻, (CF₃SO₂)₃C⁻, AsF₆⁻, SbF₆⁻, NbF₆⁻, TaF₆⁻, F(HF)ₙ⁻, (CN)₂N⁻, (CF₃SO₂)(CF₃CO)N⁻, (CH₃)₂PO₄⁻, (C₂H₅)₂PO₄⁻, CH₃ (OC₂H₄)₂OSO₃⁻, C₆H₄(CH₃)SO₃⁻, (C₂F₅)₃PF₃⁻, CH₃CH(OH)COO⁻, and (FSO₂)₂N⁻. Especially, fluorine atom-containing anion components give an ionic compound with a low melting point, and therefore they are preferably used. Further, many of nitrogen atom-containing anion components give hydrophobicity, are not dissociated even if added to a water-dispersible pressure-sensitive adhesive, and scarcely generate agglomerates, and therefore they are preferably used. Still further, sulfonyl-containing anion components are excellent in stability in water, electric conductivity, and heat stability, and therefore they are preferably used. More preferably used are lithium salts such as LiBr, LiI, LiBF₄, LiPF₆, LiSCN, LiClO₄, LiCF₃SO₃, Li(CF₃SO₂)₂N, Li(C₂F₅SO₂)₂N, Li(FSO₂)₂N, and Li(CF₃SO₂)₃C and still further preferably LiCF₃SO₃, Li(CF₃SO₂)₂N, Li(C₂F₅SO₂)₂N, Li(C₃F₇SO₂)₂N, Li(C₄F₉SO₂)₂N, Li(FSO₂)₂N, and Li(CF₃SO₂)₃C. These alkali metal salts may be used singly or in the form of a mixture of two or more of them.

The content of the ionic compound (ionic liquid or alkali metal salt) is preferably 0.5 to 3 parts by weight, more preferably 0.6 to 2 parts by weight, and most preferably 0.7 to 1.5 parts by weight to 100 parts by weight of the acrylic emulsion-based polymer (solid matter). If the content falls within the range, both the antistatic property and the low staining property are easily satisfied, and therefore it is preferable.

### [Ether Group-Containing Polysiloxane]

The water-dispersible acrylic pressure-sensitive adhesive composition may further contain an ether group-containing polysiloxane (alkylene oxide-containing polysiloxane). If the ether group-containing polysiloxane (alkylene oxide-containing polysiloxane) is contained, a more excellent antistatic property can be exhibited. The mechanism for exhibiting the antistatic property is not made clear in detail; however, it is supposed that since the ether group has high affinity to water content in the air, the transfer of electric charges to the air is easily generated, and also the ether group has high degree of freedom in molecular motion and electric charges generated at the time of peeling are efficiently transferred to the air, and therefore an excellent antistatic property is exhibited. The silicone (polysiloxane) skeleton has low surface tension, and has a high interfacial adsorption property even with a small amount so that a trace amount of the polysiloxane can be transferred evenly to the adherend surface at the time of peeling off a pressure-sensitive adhesive sheet from an adherend (object to be protected), and electric charges generated in the adhered surface can be efficiently transferred, and therefore an excellent antistatic property can be exhibited.

The ether group-containing polysiloxane (alkylene oxide-containing polysiloxane) is preferable to be composed of (contain) an ethylene oxide (EO) group. It is also possible to contain a propylene oxide (PO) group as the alkylene oxide group other than the EO group, but in this case, the mole content of the PO is preferably 50% or less to 100% of the total mole contents of the EO and the PO. If the polysiloxane is composed of the EO group (containing as a constituent component), a more excellent antistatic property can be imparted, and therefore it is a preferable aspect.

The ether group-containing polysiloxane (simply may be referred to as polysiloxane) has an HLB (hydrophile-lipophile-balance) value of preferably 4 to 12, more preferably 5 to 11, and particularly preferably 6 to 10. If the HLB value falls within the range, not only the antistatic property can be imparted but also the low staining property to an adherend is favorable, and therefore it is a preferable aspect.

Specific examples of commercially available products of the polysiloxane include trade names KF-352A, KF-353, KF-615, KF-6012, KF-351A, KF-353, KF-945, KF-6011, KF-889, and KF-6004 (all manufactured by Shin-Etsu Chemical Co., Ltd.); FZ-2122, FZ-2164, FZ-7001, SH8400, SH8700, SF8410, and SF8422 (all manufactured by Dow Corning Toray Co., Ltd.); TSF-4440, TSF-4445, TSF-4452, and TSF-4460 (manufactured by Momentive Performance Materials Inc.); BYK-333, BYK-377, BYK-UV3500, and BYK-UV3570 (manufactured by BYK Japan KK). These compounds may be used singly or in the form of a mixture of two or more of them.

Those represented by the following formula are particularly preferable aspects among the polysiloxanes since they can more easily exhibit the antistatic property in terms of restraining the ionic compound in the side chains and adsorbing the ionic compound in the interface.

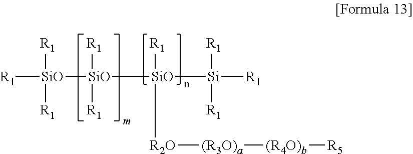

(wherein, R₁ is a monovalent organic group; R₂, R₃ and R₄ are each an alkylene group; R₅ is a hydrogen or organic group; m and n are each an integer of 0 to 1000, provided that m and n are not simultaneously 0; a and b are each an integer of 0 to 100, provided that a and b are not simultaneously 0.)

The polysiloxane is more preferable to have a hydroxyl group at the terminal of the polyoxyalkylene (polyether) side chain. If the polysiloxane is used, the antistatic property to an adherend (object to be protected) can be exhibited, and therefore it is effective.

Specifically, as the polysiloxane, R₁ in the above formula is a monovalent organic group, e.g., an alkyl group such as a methyl group, an ethyl group, or a propyl group; an aryl group such as a phenyl group or a tolyl group; or an aralkyl group such as a benzyl group or a phenethyl group, all of which may respectively have a substituent group such as a hydroxyl group. R₂, R₃, and R₄ each may be an alkylene group of 1 to 8 carbon atoms such as a methylene group, an ethylene group, or a propylene group. Herein, R₃ and R₄ are each a different alkylene group and R₂ may be the same as or different from R₃ or R₄. Either one of R₃ and R₄ is preferably an ethylene group or a propylene group in order to increase the concentration of an antistatic agent (ionic compound or the like) soluble in the polyoxyalkylene (polyether) side chain. R₅ may be a monovalent organic group, e.g., an alkyl group such as a methyl group, an ethyl group, or a propyl group; or an acyl group such as an acetyl group or a propionyl group, all of which may respectively have a substituent group such as a hydroxyl group. These compounds may be used singly or in the form of a mixture of two or more of them. These compounds may have a reactive substituent group such as a (meth)acryloyl group, an allyl group, or a hydroxyl group in the molecule. The polysiloxane having a polyoxyalkylene (polyether) side chain having a hydroxyl group at the terminal is preferable among the polysiloxanes having a polyoxyalkylene (polyether) side chain since it is supposed that the compatibility can be easily balanced.

The blend amount of the polysiloxane is preferably 0.2 to 1 part by weight, more preferably 0.25 to 0.8 parts by weight, and furthermore preferably 0.3 to 0.6 parts by weight to 100 parts by weight of the acrylic emulsion-based polymer (solid matter). If it is less than 0.2 parts by weight, the antistatic property is hard to be obtained, and if it exceeds 1 part by weight, stains to an adhered may possibly increase.

### [Repeelable Water-Dispersible Acrylic Pressure-Sensitive Adhesive Composition]

The pressure-sensitive adhesive composition of the present invention contain, as described above, an acrylic emulsion-based polymer in the invention, a crosslinking agent, an ionic compound, and a nonionic surfactant having a specified HLB value as indispensable components. If necessary, the pressure-sensitive adhesive composition may further contain various kinds of other additives. Examples of the various additives include a pigment, a filler, a leveling agent, a dispersant, a plasticizer, a stabilizer, an antioxidant, a UV absorbent, a UV stabilizer, an anti-ageing agent, a corrosion preventing agent, and a defoaming agent as long as they are added in such a range that no effect is caused on the low staining property.

The pressure-sensitive adhesive composition of the present invention is substantially preferable not to contain so-called un-reactive (un-polymerizable) components (excluding water or the like which is evaporated by drying and does not remain in the pressure-sensitive adhesive layer) other than the reactive (polymerizable) components which are incorporated into the polymer forming the pressure-sensitive adhesive layer by reaction (polymerization) with the raw material monomers of the acrylic emulsion-based polymer. If un-reactive components remain in the pressure-sensitive adhesive layer, these components are transferred to an adherend and may cause whitening as stain. Herein, “substantially not to contain” means that positive addition is not carried out except the case of inevitable mixing, and specifically, the content of the un-reactive components in the pressure-sensitive adhesive composition (non-volatile components) is preferably less than 1% by weight, more preferably less than 0.1% by weight, and furthermore preferably less than 0.005% by weight.

Examples of the un-reactive component include components such as phosphoric acid ester-based compounds used in, for example, JP-A-2006-45412 which bleed in the pressure-sensitive adhesive layer surface and impart a peeling property and also un-reactive emulsifiers such as sodium lauryl sulfate and ammonium lauryl sulfate.

As a mixing method for the pressure-sensitive adhesive composition of the present invention, conventionally known emulsion mixing methods may be employed without any particular limitation, and for example, stirring using a stirrer is preferable. The stirring condition is not particularly limited but, for example, the stirring temperature is preferably 10 to 50° C., and more preferably 20 to 35° C. The stirring time is preferably 5 to 30 minutes, and more preferably 10 to 20 minutes. The stirring rotation speed is preferably 10 to 3000 rpm, and more preferably 30 to 1000 rpm.

### [Pressure-Sensitive Adhesive Layer and Pressure-Sensitive Adhesive Sheet]

The pressure-sensitive adhesive layer (pressure-sensitive adhesive sheet) of the present invention can be formed by using the pressure-sensitive adhesive composition. A method for forming the pressure-sensitive adhesive layer is not particularly limited, and a conventionally known method for forming a pressure-sensitive adhesive layer can be used. The pressure-sensitive adhesive layer can be formed by applying the pressure-sensitive adhesive composition to a substrate or a peeling film (peeling liner, separator) and thereafter drying the pressure-sensitive adhesive composition. In addition, if the pressure-sensitive adhesive layer is formed on a peeling (release) film, the pressure-sensitive adhesive layer is bonded to a substrate and transferred.

Upon formation of the pressure-sensitive adhesive layer (pressure-sensitive adhesive sheet), the temperature at the time of drying is usually about 80 to 170° C. and preferably 80 to 160° C., and the drying time is about 0.5 to 30 minutes and preferably 1 to 10 minutes. Further, aging is carried out at room temperature to about 50° C. for one day to one week to produce the pressure-sensitive adhesive layer (pressure-sensitive adhesive sheet).

Various kinds of methods may be used for a step of applying the pressure-sensitive adhesive composition. Specific examples of the methods include roll coating, kiss roll coating, gravure coating, reverse coating, roll brushing, spray coating, dip roll coating, bar coating, knife coating, air knife coating, curtain coating, lip coating, and extrusion coating by a die coater.

The application amount is controlled so that the pressure-sensitive adhesive layer to be formed may have a prescribed thickness (thickness after drying) in the application step. The thickness of the pressure-sensitive adhesive layer (thickness after drying) is generally set in a range of about 1 to 100 μm, preferably 5 to 50 μm, and more preferably 10 to 40 μm.

The solvent-insoluble matter (gel ratio) of the pressure-sensitive adhesive layer is preferably 90% (% by weight) or more, and more preferably 95% by weight or more. If it falls within the range, good repeeling property is obtained, and therefore it is a preferable aspect.

A method for measuring the solvent-insoluble matter (gel ratio) of the pressure-sensitive adhesive layer is measured by the following method.

After about 0.1 g of a crosslinked acrylic pressure-sensitive adhesive coating was sampled and wrapped with a porous tetrafluoroethylene sheet with an average pore diameter of 0.2 μm (trade name: “NTF1122”, manufactured by Nitto Denko Corporation), the wrapped body was tied with a kite string and the weight was measured as a weight before immersion. The weight before immersion is the total weight of the crosslinked coating (sampled above), the tetrafluoroethylene sheet, and the kite string. The total weight of the tetrafluoroethylene sheet and the kite string was also measured beforehand as a wrapping weight.

Next, the crosslinked coating wrapped with the tetrafluoroethylene sheet and tied with the kite string (referred to as “sample”) was put in a 50 ml container filled with ethyl acetate, and kept still at 23° C. for 7 days. Thereafter (after ethyl acetate treatment), the sample was taken out the container and transferred to an aluminum cup and dried at 130° C. for 2 hours in a drier to remove ethyl acetate, and successively, the weight was measured as a weight after immersion. The solvent-insoluble matter was calculated according to the following equation:

Solvent-insoluble matter(% by weight)=(d−e)/(f−e)×100

wherein, d is weight after immersion; e is wrapping weight; and f is weight before immersion.

The glass transition temperature (Tg) of the acrylic emulsion-based polymer (after crosslinked) forming the pressure-sensitive adhesive layer is preferably −70 to −10° C., more preferably −70 to −20° C., furthermore preferably −70 to −40° C., and most preferably −70 to −50° C. If the glass is higher than −10° C., the adhesive strength may become so insufficient as to cause blister and peeling at the time of processing. On the other hand, if it is lower than −70° C., the peeling becomes heavy in a high peeling rate (tensile speed) region, and it may result in a decrease in working efficiency. The glass transition temperature of the polymer (after crosslinked) forming this pressure-sensitive adhesive layer can be also adjusted in accordance with, for example, the monomer composition at the time of preparing the acrylic emulsion-based polymer in the present invention.

Examples of a constituent material for the peeling film may include plastic films such as polyethylene, polypropylene, polyethylene terephthalate, and polyester films; porous materials such as paper, cloths, and nonwoven fabrics; and thin leaf materials such as a net, a foamed sheet, a metal foil, and their laminates, and a plastic film is preferably used in terms of excellent surface smoothness.

The plastic film is not particularly limited as long as it is a film for protecting the pressure-sensitive adhesive layer, and examples include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the peeling film is usually 5 to 200 μm, and preferably about 5 to 100 μm.

If necessary, the peeling film may be subjected to a releasing treatment with a silicone-based, fluorine-based, long chain alkyl-based, or fatty acid amide-based releasing agent, an antifouling treatment with a silica powder, and an antistatic treatment by coating, kneading, or vapor deposition. Particularly, if a peeling (release) treatment such as a silicone treatment, a long chain alkyl treatment, or a fluorine treatment is properly carried out for the surface of the peeling film, the peeling property from the pressure-sensitive adhesive layer can be improved.

In the case where the pressure-sensitive adhesive layer is exposed, the pressure-sensitive adhesive layer may be protected by the peeling film until the pressure-sensitive adhesive layer is practically used. The peeling film can be used as it is as a separator for a pressure-sensitive type optical film, and it can simplify the process.

In the present invention, a pressure-sensitive adhesive sheet (pressure-sensitive adhesive sheet with a substrate; pressure-sensitive adhesive sheet having the pressure-sensitive adhesive layer formed on at least one surface side of a substrate) can be obtained by forming the pressure-sensitive adhesive layer (pressure-sensitive adhesive layer formed using the pressure-sensitive adhesive composition of the present invention) on at least one surface of a substrate (referred to also as “support” or“supporting substrate”). The pressure-sensitive adhesive layer can be used as it is as a substrate-less pressure-sensitive adhesive sheet. Hereinafter, the pressure-sensitive adhesive sheet with a substrate may be referred to as “pressure-sensitive adhesive sheet of the present invention”.

For example, the pressure-sensitive adhesive sheet (pressure-sensitive adhesive sheet with a substrate) of the present invention is obtained by applying the pressure-sensitive adhesive composition of the present invention to at least one surface side of a substrate; and if necessary, drying the pressure-sensitive adhesive composition to form a pressure-sensitive adhesive layer on at least one surface side of the substrate (direct printing method). Crosslinking is carried out by dehydration in the drying step, heating the pressure-sensitive adhesive sheet after drying or the like. The pressure-sensitive adhesive sheet can be also obtained by once forming a pressure-sensitive adhesive layer on a peeling film and thereafter transferring the pressure-sensitive adhesive layer to a substrate (transfer method). Although the method is not particularly limited, the pressure-sensitive adhesive layer is preferably formed by so-called a direct printing method of directly applying the pressure-sensitive adhesive composition to the substrate surface.

The substrate for the pressure-sensitive adhesive sheet of the present invention is preferably a plastic substrate (e.g., plastic film or plastic sheet) from the viewpoint of obtaining a pressure-sensitive adhesive sheet with high transparency. A material for the plastic substrate is not particularly limited, and examples to be used include transparent resins, e.g., polyolefins (polyolefin-based resins) such as polypropylene and polyethylene; polyesters (polyester-based resins) such as polyethylene terephthalate (PET); polycarbonate, polyamide, polyimide, acryl, polystyrene, acetate, polyether sulfone, and triacetyl cellulose. These resins may be used singly or in combination of two or more of them. Among these substrates, although not particularly limited, polyester-based resins and polyolefin-based resins are preferably used, and PET, polypropylene, and polyethylene are more preferably used in terms of productivity and moldability. That is, as the substrate, polyester-based films and polyolefin-based films are preferable, and a PET film, a polypropylene film, and a polyethylene film are more preferable. Examples of the polypropylene include, but are not particularly limited to, homo-type polypropylene which is a homopolymer; random type polypropylene which is an α-olefin random copolymer; and a block type polypropylene which is an α-olefin block copolymer. Examples of the polyethylene include low density polyethylene (LDPE), high density polyethylene (HDPE), and linear low density polyethylene (L-LDPE). These plastics may be used singly or in form of a mixture of two or more of them.

The thickness of the substrate is not particularly limited, but it is preferably 10 to 150 μm and more preferably 30 to 100 μm.

For the purpose of improving the adhesion power to the pressure-sensitive adhesive layer or the like, the surface of the substrate where the pressure-sensitive adhesive layer is formed is preferably subjected to an easy adhesion treatment such as an acid treatment, an alkali treatment, a primer treatment, a corona treatment, a plasma treatment, or an ultraviolet treatment. Further, an intermediate layer may be formed between the substrate and the pressure-sensitive adhesive layer. The thickness of the intermediate layer may be preferably, for example, 0.05 to 1 μm, and more preferably 0.1 to 1 μm.

The pressure-sensitive adhesive sheet of the present invention may be formed into a winding body, and the pressure-sensitive adhesive sheet may be wound in a roll in a state where the pressure-sensitive adhesive layer is protected by a peeling film (separator). Further, the rear surface of the pressure-sensitive adhesive sheet (surface opposite to the surface where the pressure-sensitive adhesive layer is formed) may be subjected to a releasing treatment with a silicone-based, fluorine-based, long chain alkyl-based, or fatty acid amide-based releasing agent and/or an antifouling treatment with a silica powder to forma rear surface treatment layer (release treatment layer, antifouling treatment layer, etc.). The pressure-sensitive adhesive sheet of the present invention is especially preferable to have a configuration of pressure-sensitive adhesive layer/substrate/rear surface treatment layer.

The pressure-sensitive adhesive sheet of the present invention is more preferably one subjected to an antistatic treatment. The antistatic treatment may be carried out by a common antistatic treatment method and is not particularly limited, and examples to be used may include a method for forming an antistatic layer on the substrate rear surface (surface opposite to the surface where the pressure-sensitive adhesive layer is formed) and a method for kneading a kneading type antistatic agent in the substrate.

Examples of a method for forming the antistatic layer include a method of applying an antistatic resin containing an antistatic agent alone or in combination with a resin component, an electroconductive resin composition containing an electroconductive substance and a resin component, or an electroconductive polymer; or a method of performing vapor deposition or plating of an electroconductive substance.

Examples of an antistatic agent contained in an antistatic resin include a cation-type antistatic agent having a cationic functional group such as a quaternary ammonium salt, a pyridinium salt, and a primary, secondary or tertiary amino group, an anion-type antistatic agent having an anionic functional group such as a sulfonic acid salt, a sulfuric acid ester salt, a phosphonic acid salt, and a phosphoric ester salt, an amphoteric-type antistatic agent such as alkylbetain and a derivative thereof, imidazoline and a derivative thereof, and alanine and a derivative thereof, a nonion-type antistatic agent such as glycerin and a derivative thereof, and polyethylene glycol and a derivative thereof, and an ionic electrically conductive polymer obtained by polymerizing or copolymerizing a monomer having the aforementioned cation-type, anion-type, or amphoteric-type ionic electrically conductive group.

Specific examples of the cationic antistatic agents include alkyltrimethylammonium salts, acyloylamidopropyltrimethyl ammonium methosulfates, alkylbenzylmethylammonium salts, acylcholine chlorides, (meth)acrylate copolymers having a quaternary ammonium group such as polydimethylaminoethyl methacrylates, styrene-based copolymers having a quaternary ammonium group such as polyvinylbenzyltrimethylammonium chlorides, and diallylamine copolymers having a quaternary ammonium group such as polydiallyldimethylammonium chlorides. Examples of the anionic antistatic agents include alkylsulfonic acid salts, alkylbenzenesulfonic acid salts, alkylsulfuric acid ester salts, alkylethoxysulfuric acid ester salts, alkylphosphoric acid ester salts, and sulfonic acid group-containing styrene-based copolymers. Examples of the amphoteric ionic antistatic agents include alkylbetaines, alkylimidazolium betaines, and carbobetain graft copolymers. Examples of the nonionic antistatic agents include fatty acid alkylolamides, di-(2-hydroxyethyl)alkylamines, polyoxyethylene alkylamines, fatty acid glycerol esters, polyoxyethylene glycol fatty acid esters, sorbitan fatty acid esters, polyoxysorbitan fatty acid esters, polyoxyethylene alkylphenyl ethers, polyoxyethylene alkyl ethers, polyethylene glycols, polyoxyethylenediamines, copolymers composed of a polyether, a polyester and a polyamide, and methoxypolyethylene glycol(meth)acrylates.

Examples of the electrically conductive polymer include polyaniline, polypyrrole and polythiophene.

Examples of the electrically conductive substance include tin oxide, antimony oxide, indium oxide, cadmium oxide, titanium oxide, zinc oxide, indium, tin, antimony, gold, silver, copper, aluminum, nickel, chromium, titanium, iron, covert, copper iodide, and an alloy and a mixture thereof.

As a resin component used in the antistatic resin and the electrically conductive resin, a generally used resin such as polyester, acryl, polyvinyl, urethane, melanine and epoxy is used. In the case of a polymer-type antistatic agent, it is not necessary that a resin component is contained. In addition, the antistatic resin component may contain compounds of a methylolated or alkylolated melanine series, a urea series, a glyoxal series, and an acrylamide series, an epoxy compound, or an isocyanate compound as a crosslinking agent.

An examples of the method for forming the antistatic layer by application include a method for diluting the antistatic resin, electroconductive polymer, and electroconductive resin composition with a medium or dispersant such as an organic solvent or water, and applying and drying the obtained coating solution to a substrate. Examples of the organic solvent include methyl ethyl ketone, acetone, ethyl acetate, tetrahydrofuran, dioxane, cyclohexanone, n-hexane, toluene, xylene, methanol, ethanol, n-propanol, and isopropanol. These solvents may be used singly or in combination of a plurality of them. As an application method, known application methods are used, and specific examples include roll coating, gravure coating, reverse coating, roll brushing, spray coating, air knife coating, immersion and curtain coating methods.

The thickness of the antistatic layer (antistatic resin layer, electroconductive polymer layer, and electroconductive resin composition layer) formed by the application is preferably 0.001 to 5 μm and more preferably 0.005 to 1 μm.

Examples of a method of depositing or plating an electrically conductive substance include vacuum deposition, sputtering, ion plating, chemical deposition, spray pyrolysis, chemical plating, and electric plating methods.

The thickness of the antistatic layer (electroconductive substance layer) formed by vapor deposition or plating is preferably 20 to 10000 angstroms (0.002 to 1 μm), and more preferably 50 to 5000 angstroms (0.005 to 0.5 μl).

As the kneading type antistatic agent, the above-mentioned antistatic agents may be used properly. The blend amount of the kneading type antistatic agent is preferably 20% by weight or less, and more preferably 0.05 to 10% by weight to the total weight (100% by weight) of the substrate. A method for kneading is not particularly limited as long as the method can evenly mix the kneading type antistatic agent with the resin to be used for, for example, a plastic substrate, and examples include generally methods using a heating roll, a Banbury mixer, a pressure kneader, a biaxial kneader, and the like.

### [Use]

The pressure-sensitive adhesive composition of the present invention is a pressure-sensitive adhesive composition excellent in antistatic property, adherability (tackiness), repeeling property (light peeling property, easy peeling property) and appearance property, and capable of forming a repeelable pressure-sensitive adhesive layer, and is used for forming a pressure-sensitive adhesive layer to be used for re-peeling. That is, the pressure-sensitive adhesive sheet having the pressure-sensitive adhesive layer may be used preferably for re-peeling [e.g., masking tapes such as a masking tape for construction aging, a masking tape for automotive coating, a masking tape for electronic parts (lead frame, printed board, etc.), and a masking tape for sand blast; surface protective films such as a surface protective film for aluminum sashes, a surface protective film for optical plastics, a surface protective film for optical glass, a surface protective film for automotive protection, and a surface protective film for metal plates; pressure-sensitive taps for semiconductor/electronic part production process such as a back-grind tape, a tape for pellicle fixation, a tape for dicing, a tape of lead frame fixation, a cleaning tape, a dust removal tape, a carrier tape, and a cover tape; wrapping tapes for electronic appliances and electronic parts; temporary fixation tapes for transportation, bundling tapes; and labels].

When the pressure-sensitive adhesive layer (pressure-sensitive adhesive sheet) formed by using the pressure-sensitive adhesive composition of the present invention is used while being bonded to an adherend, it does not cause stains such as whitening on the adherend and is thus excellent in low staining property. For this reason, the pressure-sensitive adhesive sheet of the present invention is preferably used for surface protecting uses (surface protective films for optical members, etc.) of optical members (optical plastics, optical glass, optical films, etc.) such as polarizing plates, retardation plates, anti-reflection plates, wave plates, optical compensation films, and brightness improvement films forming panels such as liquid crystal display panels, organic electroluminescence (organic EL) displays, and field emission displays, for which the low staining property is required. However, the use of the pressure-sensitive adhesive sheet is not limited thereto, and may also include for surface-protection, failure-prevention, removal of foreign matter, or masking upon production of microfabricated components of semiconductors, circuits, printed circuit boards, masks, and lead frames.

### EXAMPLES

Hereinafter, the present invention will be described in more detail with reference to the working examples; however, the invention should not be limited thereto. In the following description, “part” and “%” are based on weight unless otherwise specified.

### Example 1

### Preparation of Acrylic Emulsion-Based Polymer

After 90 parts by weight of water and, as shown in Table 1, 92 parts by weight of 2-ethylhexyl acrylate (2EHA), 4 parts by weight of acrylic acid (AA), 4 parts by weight of methyl methacrylate (MMA), and 2 parts by weight of a reactive nonionic anionic emulsifier (trade name; “Aqualon HS-1025”, manufactured by Dai-Ichi Kogyo Seiyaku Co., Ltd.) were loaded to a container, the mixture was stirred and mixed by a homomixer to prepare a monomer emulsion.

Next, a reaction container equipped with a condenser, a nitrogen gas introduction tube, a thermometer, and a stirrer was charged with 50 parts by weight of water and 0.07 parts by weight of a polymerization initiator (ammonium persulfate), and heated to 75° C. While the mixture was stirred in a nitrogen atmosphere, the monomer emulsion was added for 3 hours and emulsion polymerization was performed at 75° C. for 3 hours. Thereafter, the resulting reaction mixture was cooled to 30° C. and mixed with ammonia water having a concentration of 10% by weight to adjust the pH to 8, and thus a water dispersion of an acrylic emulsion-based polymer (concentration of acrylic emulsion-based polymer: 42% by weight) was prepared.

### (Preparation of Repeelable Water-Dispersible Acrylic Pressure-Sensitive Adhesive Composition)

To the water dispersion of the acrylic emulsion-based polymer (to 100 parts by weight of the acrylic emulsion-based polymer (solid matter)) were added and mixed 1.8 parts by weight of an epoxy-based crosslinking agent serving as a water-insoluble crosslinking agent [trade name: “TETRAD-C”; manufactured by Mitsubishi Gas Chemical Company, Inc.; 1,3-bis(N,N-diglycidylaminomethyl)cyclohexane; epoxy equivalent: 110; and number of functional groups: 4], 1 part by weight of 1-ethyl-3-methylimidazoliumbisfluorosulfonylimide [trade name: “Elexel AS-110”, manufactured by Dai-Ichi Kogyo Seiyaku Co., Ltd.; efficacious component 100% by weight], 0.32 parts by weight of an ether group-containing polysiloxane [trade name: “KF-353”, manufactured by Shin-Etsu Silicone Co., Ltd.; efficacious component 100% by weight], and 1 part by weight of an acetylene diol-based compound (composition) with an HLB value of 8 [trade name: “Surfynol 440”, manufactured by Air-Products & Chemicals, Inc.; efficacious component 100% by weight] with stirring using a stirrer under conditions of 23° C. and 2000 rpm for 10 minutes so that a repeelable water-dispersible acrylic pressure-sensitive adhesive composition was prepared.

### (Formation of Pressure-Sensitive Adhesive Layer and Production of Pressure-Sensitive Adhesive Sheet)

The repeelable water-dispersible acrylic pressure-sensitive adhesive composition was applied (coated) onto the corona-treated surface of a PET film (trade name: “T100M38”, manufactured by Mitsubishi Plastics Inc.; thickness: 38 μm) to give a thickness of 20 μm after drying by using an applicator manufactured by Tester Sangyo Co., Ltd., and then dried at 120° C. for 2 minutes in a hot air circulation type oven and successively aged at 50° C. for one day to obtain a pressure-sensitive adhesive sheet.

### Examples 2 to 8 and Comparative Examples 1 to 3

The kinds and blend amounts of raw material monomers, nonionic surfactants (acetylene diol-based compounds) and the like were changed as shown in Table 1, and pressure-sensitive adhesive compositions and pressure-sensitive adhesive sheets were obtained in the same manner as in Example 1. Additives not described in the table were blended in the same blend amounts as those in Example 1.

### [Evaluation]

Each water-dispersible acrylic pressure-sensitive adhesive composition and each pressure-sensitive adhesive sheet obtained in the examples and the comparative examples were evaluated by the following measurement method or evaluation method. The evaluation results are shown in Table 2.

### <Measurement of Average Particle Diameter of Acrylic Emulsion-Based Polymer>

An LS 1332 laser diffraction/scattering particle size distribution analyzer manufactured by BECKMAN COULTER was used for the measurement of the average particle diameter of the emulsion particles. The pump speed was 30% and the measurement time was 90 seconds. An emulsion pressure-sensitive adhesive diluted 10 times was set for the measurement.

Since the emulsion particles produced from the acrylic emulsion-based polymer bear electric charge, and therefore restrict an ionic liquid, so that the emulsion particles generally work disadvantageously for electrification prevention. Accordingly, the antistatic property can be improved by making the average particle diameter of the emulsion particles large. The reason for this is because the total surface area is widened as compared with the case where the average particle diameter is small, the amount of the restricted ionic liquid is lowered, and the ionic liquid tends to bleed out to the adherend surface, so that the antistatic property can be improved.

Generally, emulsion particles bear electric charge on the particle surface, and therefore an ionic compound tends to be easily restricted on the surface. As a result, it is supposed that the amount of the ionic compound to be transferred to an adherend is decreased at the time when a pressure-sensitive adhesive is peeled off from an adherend, and the antistatic property is difficult to be exhibited at the time of peeling. Herein, if the average particle diameter of the emulsion particles is increased, the surface area of respective particles is increased, but the number of the particles contained in the same solid matter concentration and the same volume is lessened, and the total surface area of the particles is decreased. As a result, it is supposed that the amount of the ionic compound to be restricted on the particle surface is lowered, and the antistatic property can be improved. The average particle diameter is preferably 130 to 1000 nm, more preferably 150 to 500 nm, and even more preferably 200 to 450 nm.

### [Peeling Electrification Voltage]

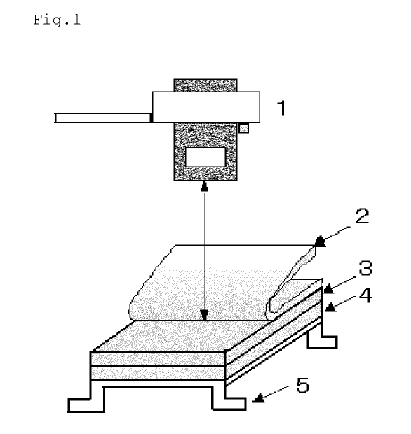

Each produced pressure-sensitive adhesive sheet was cut into a size of 70 mm width and 120 mm length, and after the separator was peeled off, the pressure-sensitive adhesive sheet was pressure-bonded to the surface of a polarizing plate (trade names: “SEG 1425 DU”, “AGS1”, and “ARC150T”, manufactured by Nitto Denko Corporation) stuck to an acrylic plate (Acrylite, manufactured by Mitsubishi Rayon Co., Ltd.; thickness: 1 mm; width: 70 mm; length: 100 mm), which was previously treated for static elimination, by a hand roller so that one rim part was extruded out by 20 mm. Successively, after the resultant was left in environments of 20° C.×25±2% RH for one day, the sample was set at a prescribed position as shown in FIG. 1. The one rim part extruded by 20 mm was fixed in an automatic winder and the pressure-sensitive adhesive sheet was peeled off at a peeling angle of 150° and a peeling rate of 30 m/minute. The potential generated in the polarizing plate surface at that time was measured by a potentiometer (KSD-0103, manufactured by Kasuga Electric Works Ltd.) fixed at a prescribed position. The distance between the sample and the potentiometer was 100 mm at the time of measuring the potential in the polarizing plate surface. The measurement was carried out in environments of 20° C.×25±2% RH and 23° C.×50±2% RH. The respective properties of the trade names: “SEG 1425 DU”, “AGS1”, and “ARC150T” were such that SEG 1425 DU was subjected to no treatment, AGS1 was subjected to an anti-glare treatment, and ARC150 T was subjected to an anti-reflection treatment.

The peeling electrification voltage (absolute value) of the pressure-sensitive adhesive sheet of the present invention is preferably 1.0 kV or less, more preferably 0.8 kV or less, even more preferably 0.5 kV or less, and particularly preferably 0 kV. If the peeling electrification voltage exceeds 1.0 kV, the polarizer arrangement in the polarizing plate is disordered and dust is easily adsorbed at the time of peeling off the pressure-sensitive adhesive sheet, and therefore it is not preferable.

### [Initial Peeling Strength to DU]

Each produced pressure-sensitive adhesive sheet was cut into a size of 25 mm width and 100 mm length, and after the separator was peeled off, the pressure-sensitive adhesive sheet was laminated on a polarizing plate (SEG 1425DU, manufactured by Nitto Denko Corporation; width: 70 mm; length: 100 mm) by a bonding machine (Compact bonding machine, manufactured by Tester Sangyo Co., Ltd.) in conditions of 0.25 MPa and 0.3 m/minute to obtain an evaluation sample. After the lamination, the sample was left in conditions of 23° C.×50% RH for 30 minutes and subjected to measurement of a pressure-sensitive peeling strength (adhesive strength) (N/25 mm) at the time of peeling off at a peeling angle of 180° and a peeling rate of 0.3 m/minute as “initial peeling strength to DU”. The measurement was carried out in environments of 23° C.×50% RH.

The initial peeling strength of the pressure-sensitive adhesive sheet of the present invention is preferably 0.1 to 1.0 N/25 mm, and more preferably 0.3 to 0.8 N/25 mm. If the peeling strength is set to 1.0 N/25 mm or less, the pressure-sensitive adhesive sheet becomes easy to be peeled off and the productivity and the handling property are improved in the process for producing polarizing plates and liquid crystal display panels, and therefore it is preferable. Further, if the peeling strength is set to 0.1 N/25 mm, the blistering and peeling separation of the pressure-sensitive adhesive sheet is suppressed during the production process and the protecting function as a surface-protecting pressure-sensitive adhesive sheet is sufficiently exhibited, and therefore it is preferable.

### [Appearance (Presence or Absence of Dents and Gel)]

The state of the pressure-sensitive adhesive layer surface of each pressure-sensitive adhesive sheet obtained in the examples and comparative examples was visually observed. The number of defects (dents and gel) in an observation range of 10 cm wide×10 cm long was counted and evaluated based on the following criteria.

The number of defects 0 to 100: good appearance (∘)

The number of defects 101 or more: poor appearance (x)

TABLE 1

| | | | | | | | | | | | Comparative | | |
|---|---|---|---|---|---|---|---|---|---|---|---|---|---|
| | | | Examples | | | | | | | | Examples | | |
| Contents to be blended (unit: part by weight) | | | 1 | 2 | 3 | 4 | 5 | 6 | 7 | 8 | 1 | 2 | 3 |
| Acrylic | Monomer | 2EHA | 92 | 92 | 92 | 92 | 92 | 92 | 92 | 92 | 92 | 92 | 92 |
| emulsion-based | component | AA | 4 | 4 | 4 | 4 | 4 | 4 | 4 | 4 | 4 | 4 | 4 |
| polymer | | MMA | 4 | 4 | 4 | 4 | 4 | 4 | 4 | 4 | 4 | 4 | 4 |
| | Reactive | HS-1025 | 2 | 2 | 2 | 2 | 2 | 2 | 2 | 2 | 2 | 2 | 2 |
| | emulsifier | | | | | | | | | | | | |
| | Average particle diameter (nm) | | 220 | 220 | 220 | 220 | 220 | 220 | 220 | 220 | 220 | 220 | 220 |
| Pressure- | Acrylic emulsion-based polymer | | 100 | 100 | 100 | 100 | 100 | 100 | 100 | 100 | 100 | 100 | 100 |
| sensitive | Water- | T/C | 1.8 | 1.8 | 1.8 | 1.8 | 1.8 | 1.8 | 1.8 | 1.8 | 1.8 | 1.8 | 1.8 |
| adhesive | insoluble | | | | | | | | | | | | |
| composition | crosslinking | | | | | | | | | | | | |
| | agent | | | | | | | | | | | | |
| | Ionic | AS-110 | 1 | 1 | 1 | 1 | 1 | 1 | 1 | 1 | 1 | 1 | 1 |
| | compound | | | | | | | | | | | | |
| | Ether group- | KF-353 | 0.32 | 0.32 | 0.32 | 0.2 | 0.1 | 0.32 | 0.32 | 0.32 | 0.32 | 0.32 | 0.32 |
| | containing | | | | | | | | | | | | |
| | polysiloxane | | | | | | | | | | | | |
| | Nonionic | Surfynol 420 | | | | | | | | | | 1 | 3 |
| | surfactant | (HLB: 4) | | | | | | | | | | | |
| | | Surfynol 440 | 1 | | | | | | | | | | |
| | | (HLB: 8) | | | | | | | | | | | |
| | | Surfynol 465 | | 1 | | | | | | | | | |
| | | (HLB: 13) | | | | | | | | | | | |
| | | Surfynol 485 | | | 1 | 1 | 1 | | | | | | |
| | | (HLB: 17) | | | | | | | | | | | |
| | | Acetylenol E 80 | | | | | | 1 | | | | | |
| | | (HLB: 11 to 12) | | | | | | | | | | | |
| | | Acetylenol E 81 | | | | | | | 1 | | | | |
| | | (HLB: 12.2) | | | | | | | | | | | |
| | | Acetylenol E 100 | | | | | | | | 1 | | | |
| | | (HLB: 13-14) | | | | | | | | | | | |

The contents to be blended in Table 1 are shown by weight of solid matter.
The abbreviations used in Table 1 are as follows.
(Monomer components)
2EHA: 2-ethylhexyl acrylate
AA: acrylic acid
MMA: methyl methacrylate
(Emulsifier)
HS-1025: trade name: “Aqualon HS-1025” manufactured by Dai-Ichi Kogyo Seiyaku Co., Ltd., (reactive nonionic anionic emulsifier)
(Crosslinking agent)
T/C: trade name: “TETRAD-C”, manufactured by Mitsubishi Gas Chemical Company, Inc., (1,3-bis(N,N-diglycidylaminomethyl)cyclohexane, epoxy equivalent: 110, number of functional groups: 4) (water-insoluble crosslinking agent
(Ionic compound)
AS-110: trade name: “Elexel AS-110”, manufactured by Dai-Ichi Kogyo Seiyaku Co., Ltd. (1-ethyl-3-methylimidazoliumbisfluorosulfonylimide, efficacious component 100% by weight) (ionic liquid)
(Ether group-containing polysiloxane)
KF-353: trade name: “KF-353”, manufactured by Shin-Etsu Silicone Co., Ltd.
(Nonionic surfactant)
Surfynol 420: trade name: “Surfynol 420”, manufactured by Air-Products & Chemicals, Inc. (HLB value: 4, efficacious component 100% by weight, acetylene diol-based compound)
Surfynol 440: trade name: “Surfynol 440”, manufactured by Air-Products & Chemicals, Inc. (HLB value: 8, efficacious component 100% by weight, acetylene diol-based compound)
Surfynol 465: trade name: “Surfynol 465”, manufactured by Air-Products & Chemicals, Inc. (HLB value: 17, efficacious component 100% by weight, acetylene diol-based compound)
Surfynol 485: trade name: “Surfynol 485”, manufactured by Air-Products & Chemicals, Inc. (HLB value: 17, efficacious component 100% by weight, acetylene diol-based compound)
Acetylenol E 60: trade name: “Acetylenol E 60”, manufactured by Kawaken Fine Chemicals Co., Ltd. (HLB value: 11 to 12, efficacious component 98% by weight or more, acetylene glycol-based compound)
Acetylenol E 81: trade name: “Acetylenol E 81”, manufactured by Kawaken Fine Chemicals Co., Ltd. (HLB value: 12.2, efficacious component 98% by weight or more, acetylene glycol-based compound)
Acetylenol E 100: trade name: “Acetylenol E 100”, manufactured by Kawaken Fine Chemicals Co., Ltd. (HLB value: 13 to 14, efficacious component 98% by weight or more, acetylene glycol-based compound)

TABLE 2

| | | | | | | | | | | | Comparative | | |
|---|---|---|---|---|---|---|---|---|---|---|---|---|---|
| | | | Examples | | | | | | | | Examples | | |
| Evaluation results | | | 1 | 2 | 3 | 4 | 5 | 6 | 7 | 8 | 1 | 2 | 3 |
| Pressure- | Peeling | To DU | 0.1 | 0.1 | 0.0 | 0.0 | 0.0 | 0.2 | 0.4 | 0.3 | 0.3 | 0.0 | 0.0 |
| sensitive | electrification | To AGS1 | 0.2 | 0.1 | 0.0 | 0.1 | 0.1 | 0.2 | 0.2 | 0.2 | 0.5 | 0.3 | 0.7 |
| adhesive | voltage (absolute | To ARC150T | 0.8 | 0.2 | 0.0 | 0.1 | 0.7 | 0.7 | 0.5 | 0.5 | 1.6 | 1.4 | 1.6 |
| sheet | value: kV) | | | | | | | | | | | | |
| | 20° C. × 25% RH | | | | | | | | | | | | |
| | Peeling rate: | | | | | | | | | | | | |
| | 30 m/minute | | | | | | | | | | | | |
| | Peeling | To DU | 0.1 | 0.1 | 0.0 | 0.0 | 0.0 | 0.4 | 0.6 | 0.3 | 0.2 | 0.0 | 0.0 |
| | electrification | To AGS1 | 0.1 | 0.1 | 0.0 | 0.0 | 0.1 | 0.1 | 0.2 | 0.1 | 0.0 | 0.2 | 0.1 |
| | voltage (absolute | To ARC150T | 0.5 | 0.3 | 0.0 | 0.0 | 0.2 | 0.1 | 0.1 | 0.1 | 0.7 | 0.5 | 0.6 |
| | value: kV) | | | | | | | | | | | | |
| | 20° C. × 50% RH | | | | | | | | | | | | |
| | Peeling rate: | | | | | | | | | | | | |
| | 30 m/minute | | | | | | | | | | | | |
| | Initial peeling | To DU | 0.3 | 0.4 | 0.4 | 0.4 | 0.5 | 0.2 | 0.4 | 0.3 | 0.2 | 0.3 | 0.2 |
| | strength | | | | | | | | | | | | |
| | (N/25 mm) | | | | | | | | | | | | |
| | Peeling rate: | | | | | | | | | | | | |
| | 30 m/minute | | | | | | | | | | | | |

| | | | | | | | | | | | |
|---|---|---|---|---|---|---|---|---|---|---|---|
| Appearance | ◯ | ◯ | ◯ | ◯ | ◯ | ◯ | ◯ | ◯ | X | ◯ | ◯ |

From the evaluation results in Table 2, it was confirmed that pressure-sensitive adhesive layers (pressure-sensitive adhesive sheets) excellent in antistatic property, repeeling property, and appearance property could be obtained in all the examples.

On the other hand, from the evaluation results in Table 2, in Comparative Example 1, since a nonionic surfactant having a specified HLB value was not used, the antistatic property and the appearance property were inferior; and in Comparative Examples 2 and 3, since an acetylene diol-based compound serving as a nonionic surfactant having a specified HLB value was blended but a nonionic surfactant having a specified HLB value was not used, the antistatic property was inferior as a result. Particularly, as a reason for the inferiority of the peeling electrification voltage to the ARC150T surface with low polarity as compared with that in the examples is supposedly attributed to that a nonionic surfactant having a specified HLB value was not used, and therefore it was difficult to transfer the ionic compound (antistatic agent) with high polarity.
1 Potential meter
2 Pressure-sensitive adhesive sheet
3 Polarizing plate
4 Acrylic plate
5 Sample mount

1. A repeelable water-dispersible acrylic pressure-sensitive adhesive composition comprising an acrylic emulsion-based polymer composed of 70 to 99.5% by weight of a (meth)acrylic acid alkyl ester and 0.5 to 10% by weight of a carboxyl group-containing unsaturated monomer as monomer components, a crosslinking agent, an ionic compound, and a nonionic surfactant with an HLB value of 6 or more.

2. The repeelable water-dispersible acrylic pressure-sensitive adhesive composition according to claim 1, wherein the nonionic surfactant includes an acetylene structure.

3. The repeelable water-dispersible acrylic pressure-sensitive adhesive composition according to claim 1, wherein the nonionic surfactant includes an acetylenediol structure.

4. The repeelable water-dispersible acrylic pressure-sensitive adhesive composition according to claim 1, wherein the ionic compound contains a fluorine atom-containing anion.

5. The repeelable water-dispersible acrylic pressure-sensitive adhesive composition according to claim 1, wherein the ionic compound contains a nitrogen atom-containing anion.

6. The repeelable water-dispersible acrylic pressure-sensitive adhesive composition according to claim 1, wherein the ionic compound contains a sulfonyl-containing anion.

7. The repeelable water-dispersible acrylic pressure-sensitive adhesive composition according to claim 1, wherein the ionic compound is an ionic liquid and
the ionic compound contains at least one cation selected from the group consisting of cations represented by the following formulas (A) to (E): 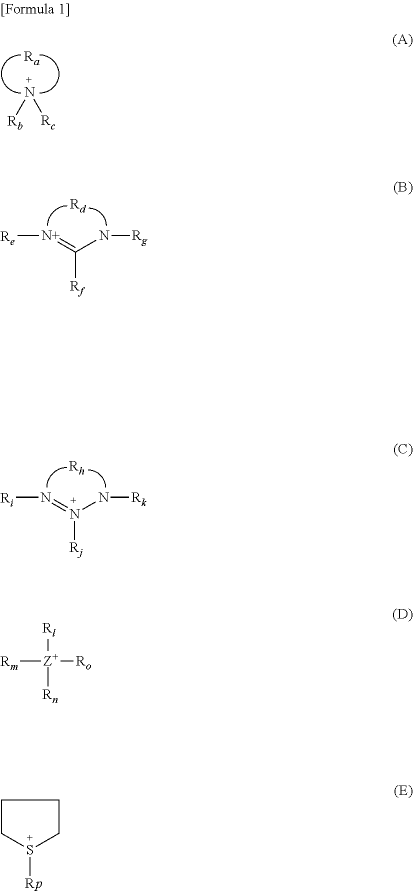
wherein, Rₐ in the formula (A) represents a hydrocarbon group of 4 to 20 carbon atoms or may be a functional group formed by substituting a portion of the hydrocarbon group with a hetero atom; R_{b} and R_{c} may be the same as or different from each other and each represent hydrogen, a hydrocarbon group of 1 to 16 carbon atoms, or may be a functional group formed by substituting a portion of the hydrocarbon group with a hetero atom; provided that when a nitrogen atom includes a double bond, R^{c} is absent:
R_{d} in the formula (B) represents a hydrocarbon group of 2 to 20 carbon atoms or may be a functional group formed by substituting a portion of the hydrocarbon group with a hetero atom; Rₑ, R_{f}, and R_{g} may be the same as or different from one another and each represent hydrogen, a hydrocarbon group of 1 to 16 carbon atoms, or may be a functional group formed by substituting a portion of the hydrocarbon group with a hetero atom:
Rₕ in the formula (C) represents a hydrocarbon group of 2 to 20 carbon atoms or may be a functional group formed by substituting a portion of the hydrocarbon group with a hetero atom; Rᵢ, Rⱼ, and Rₖ may be the same or different from one another and each represent hydrogen, a hydrocarbon group of 1 to 16 carbon atoms, or may be a functional group formed by substituting a portion of the hydrocarbon group with a hetero atom:
Z in the formula (D) represents a nitrogen, sulfur, or phosphorus atom; Rₗ, Rₘ, Rₙ, and Rₒ may be the same as or different from one another and each represent a hydrocarbon group of 1 to 20 carbon atoms or may be a functional group formed by substituting a portion of the hydrocarbon group with a hetero atom; provided that in the case where Z is a sulfur atom, Rₒ is absent: and
Rₚ in the formula (E) represents a hydrocarbon group of 1 to 18 carbon atoms or may be a functional group formed by substituting a portion of the hydrocarbon group with a hetero atom.

8. The repeelable water-dispersible acrylic pressure-sensitive adhesive composition according to claim 7, wherein the ionic liquid is of at least one selected from the group consisting of imidazolium-containing salt type, pyridinium-containing salt type, morpholinium-containing salt type, pyrrolidinium-containing salt type, piperidinium-containing salt type, ammonium-containing salt type, phosphonium-containing salt type, and sulfonium-containing salt type.

9. The repeelable water-dispersible acrylic pressure-sensitive adhesive composition according to claim 7, wherein the ionic liquid contains at least one cation selected from the group consisting of cations represented by the following formulas (a) to (d): 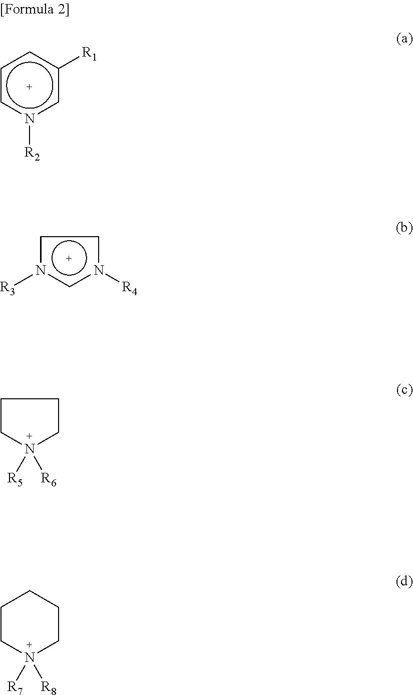
wherein, R₁ in the formula (a) represents hydrogen or a hydrocarbon group of 1 to 3 carbon atoms; and R₂ represents hydrogen or a hydrocarbon group of 1 to 5 carbon atoms:
R₃ in the formula (b) represents hydrogen or a hydrocarbon group of 1 to 3 carbon atoms; and R₄ represents hydrogen or a hydrocarbon group of 1 to 5 carbon atoms:
R₅ in the formula (c) represents hydrogen or a hydrocarbon group of 1 to 3 carbon atoms; and R₆ represents hydrogen or a hydrocarbon group of 1 to 5 carbon atoms: and
R₇ in the formula (d) represents hydrogen or a hydrocarbon group of 1 to 3 carbon atoms; and R₈ represents hydrogen or a hydrocarbon group of 1 to 5 carbon atoms.

10. The repeelable water-dispersible acrylic pressure-sensitive adhesive composition according to claim 1, wherein the ionic compound is an alkali metal salt.

11. The repeelable water-dispersible acrylic pressure-sensitive adhesive composition according to claim 10, wherein the alkali metal salt is a lithium salt.

12. The repeelable water-dispersible acrylic pressure-sensitive adhesive composition according to claim 1, which contains 0.5 to 3 parts by weight of the ionic compound to 100 parts by weight of solid matter of the acrylic emulsion-based polymer.

13. The repeelable water-dispersible acrylic pressure-sensitive adhesive composition according to claim 1, which contains 0.01 to 10 parts by weight of the nonionic surfactant to 100 parts by weight of solid matter of the acrylic emulsion-based polymer.

14. The repeelable water-dispersible acrylic pressure-sensitive adhesive composition according to claim 1, which contains 0.2 to 1 part by weight of an ether group-containing polysiloxane to 100 parts by weight of solid matter of the acrylic emulsion-based polymer.

15. The repeelable water-dispersible acrylic pressure-sensitive adhesive composition according to claim 1, wherein the acrylic emulsion-based polymer is a polymer obtained by polymerization using a reactive emulsifier containing a radical polymerizable functional group in the molecule.

16. The repeelable water-dispersible acrylic pressure-sensitive adhesive composition according to claim 1, wherein the acrylic emulsion-based polymer has an average particle diameter of 130 nm to 1000 nm.

17. A pressure-sensitive adhesive sheet having a substrate and a pressure-sensitive adhesive layer formed by using the repeelable water-dispersible acrylic pressure-sensitive adhesive composition according to claim 1 on at least one surface side of the substrate.

18. The pressure-sensitive adhesive sheet according to claim 17, which is a surface protective film for an optical member.
